(19) United States
(12) Patent Application Publication
(10) Pub. No.: US 2022/0245716 A1
(43) Pub. Date: Aug. 4, 2022

(54) NON-TRANSITORY COMPUTER READABLE MEDIUM STORING VIRTUAL STORE MANAGEMENT PROGRAM AND VIRTUAL STORE MANAGEMENT SYSTEM

(71) Applicant: SQUARE ENIX CO., LTD., Tokyo (JP)

(72) Inventors: MAKOTO TSUDA, Tokyo (JP); KEITA SHIBATA, Tokyo (JP); MANAMI FUSHIKI, Tokyo (JP)

(73) Assignee: SQUARE ENIX CO., LTD., Tokyo (JP)

(21) Appl. No.: 17/649,647

(22) Filed: Feb. 1, 2022

(30) Foreign Application Priority Data
Feb. 1, 2021 (JP) 2021-014455

(51) Int. Cl. G06Q 30/06; G06T 19/00; G06F 9/54

(52) U.S. Cl. CPC G06Q 30/0643; G06F 9/54; G06T 19/006

(57) ABSTRACT

A non-transitory computer readable medium storing a virtual store management program causing a server to implement an augmented reality diorama display function of displaying an augmented reality diorama superimposed on a real space on a display device, a space region link function of linking one or more virtual space regions to the augmented reality diorama, and a space region display function of displaying the space region linked to the augmented reality diorama on the display device is provided.

### CROSS-REFERENCE TO RELATED APPLICATION(S)

This application claims priority to and the benefit of Japanese Patent Application No. 2021-014455, filed on Feb. 1, 2021, the disclosure of which is expressly incorporated herein by reference in its entirety for any purpose.

### BACKGROUND

At least one embodiment of the present disclosure relates to a non-transitory computer readable medium storing a virtual store management program and a virtual store management system.

### DESCRIPTION OF RELATED ART

A product sales site for selling products on a website arranged on the Internet has been known.

For example, Japanese Patent No. 5801981 discloses an electronic transaction terminal including a presentation unit that presents a product page on which products and placed objects associated with the products are posted to a customer, a reception unit that receives an instruction from the customer, and a placing unit that, in a case where a first instruction to select a product associated with a placed object is received, places the selected product in an electronic cart of the customer. In the electronic transaction terminal, in a case where the product is placed in the electronic cart, the presentation unit, (a) in a case where a transition condition is satisfied, causes a page to be presented to the customer to transition from the product page to a purchase page on which payment for purchasing the product already placed in the electronic cart is started. In the electronic transaction terminal, the presentation unit, (b) in a case where the transition condition is not satisfied, presents a placing notification indicating that the product shown on the product page is placed in the electronic cart, together with the product page, waits until a second instruction to select another product is received by the reception unit, and then, causes the page to be presented to the customer to transition from the product page to a product page showing the selected other product.

### SUMMARY

Augmented reality (AR) technology for outputting a virtual object or the like in a superimposed manner on a real space has been developed. In a case where a space region corresponding to a virtual store and an augmented reality diorama linked to the space region can be dynamically arranged, a user can perform various transaction actions such as purchasing a product in a preferred virtual space and receiving provision of a service.

An object of at least one embodiment of the present disclosure is to solve the above problem and enable a user to perform various transaction actions in a preferred virtual space.

From a non-limiting viewpoint, a non-transitory computer readable medium storing a virtual store management program according to one embodiment of the present disclosure causes a server to implement an augmented reality diorama display function of displaying an augmented reality diorama superimposed on a real space on a display device, a space region link function of linking one or more virtual space regions to the augmented reality diorama, and a space region display function of displaying the space region linked to the augmented reality diorama on the display device.

From a non-limiting viewpoint, a virtual store management system according to one embodiment of the present disclosure is a virtual store management system including a communication network, a server, and a user terminal and includes augmented reality diorama display means for displaying an augmented reality diorama superimposed on a real space on a display device, space region link means for linking one or more virtual space regions to the augmented reality diorama, and space region display means for displaying the space region linked to the augmented reality diorama on the display device.

From a non-limiting viewpoint, a non-transitory computer readable medium storing a virtual store management program according to one embodiment of the present disclosure causes a user terminal to implement an augmented reality diorama display function of displaying an augmented reality diorama superimposed on a real space on a display device, a space region link function of linking one or more virtual space regions to the augmented reality diorama, and a space region display function of displaying the space region linked to the augmented reality diorama on the display device.

Each embodiment of the present application solves one or two or more deficiencies.

### BRIEF DESCRIPTION OF THE DRAWINGS

FIG. 1 is a diagram illustrating an example of a configuration of a virtual store management system according to at least one embodiment of the present disclosure.

FIG. 2 is a block diagram illustrating a configuration of a server according to at least one embodiment of the present disclosure.

FIG. 3 is a flowchart illustrating an example of a virtual store management process according to at least one embodiment of the present disclosure.

FIG. 4 is a block diagram illustrating a configuration of the server according to at least one embodiment of the present disclosure.

FIG. 5 is a flowchart illustrating an example of the virtual store management process according to at least one embodiment of the present disclosure.

FIG. 6 is a block diagram illustrating a configuration of the server according to at least one embodiment of the present disclosure.

FIG. 7 is a flowchart illustrating an example of the virtual store management process according to at least one embodiment of the present disclosure.

FIG. 8 is a block diagram illustrating a configuration of the server according to at least one embodiment of the present disclosure.

FIG. 9 is a flowchart illustrating an example of the virtual store management process according to at least one embodiment of the present disclosure.

FIG. 10 is a block diagram illustrating a configuration of the server according to at least one embodiment of the present disclosure.

FIG. 11 is a flowchart illustrating an example of the virtual store management process according to at least one embodiment of the present disclosure.

FIG. 12 is a block diagram illustrating a configuration of the server according to at least one embodiment of the present disclosure.

FIG. 13 is a flowchart illustrating an example of the virtual store management process according to at least one embodiment of the present disclosure.

FIG. 14 is a diagram illustrating an example of a configuration of the virtual store management system according to at least one embodiment of the present disclosure.

FIG. 15 is a block diagram illustrating the configuration of the virtual store management system according to at least one embodiment of the present disclosure.

FIG. 16 is a flowchart illustrating an example of the virtual store management process according to at least one embodiment of the present disclosure.

FIG. 17 is a block diagram illustrating a configuration of a user terminal according to at least one embodiment of the present disclosure.

FIG. 18 is a flowchart illustrating an example of the virtual store management process according to at least one embodiment of the present disclosure.

FIG. 19 is a block diagram illustrating a configuration of the server according to at least one embodiment of the present disclosure.

FIG. 20 is a flowchart illustrating an example of the virtual store management process according to at least one embodiment of the present disclosure.

FIG. 21 is a conceptual diagram illustrating a display example of an augmented reality diorama by a display device according to at least one embodiment of the present disclosure.

FIG. 22 is a conceptual diagram illustrating a display example of a space region by the display device according to at least one embodiment of the present disclosure.

FIG. 23 is a flowchart illustrating an example of the virtual store management process according to at least one embodiment of the present disclosure.

FIG. 24 is a conceptual diagram illustrating association of an avatar with a user according to at least one embodiment of the present disclosure.

FIG. 25 is a conceptual diagram illustrating changing of a parameter or a form of the avatar according to at least one embodiment of the present disclosure.

FIG. 26 is a conceptual diagram illustrating a look of the avatar in a view from another user according to at least one embodiment of the present disclosure.

FIG. 27 is a conceptual diagram illustrating an example of combining a virtual object with the avatar according to at least one embodiment of the present disclosure.

FIG. 28 is a conceptual diagram illustrating an example of combining the virtual object with the avatar according to at least one embodiment of the present disclosure.

FIG. 29 is a flowchart illustrating an example of the virtual store management process according to at least one embodiment of the present disclosure.

FIG. 30 is a conceptual diagram illustrating a display example of a transaction screen according to at least one embodiment of the present disclosure.

FIG. 31 is a conceptual diagram illustrating a display example of a reception character having a parameter or a form corresponding to an actual article according to at least one embodiment of the present disclosure.

FIG. 32 is a conceptual diagram illustrating a control example of the reception character according to at least one embodiment of the present disclosure.

FIG. 33 is a flowchart illustrating an example of the virtual store management process according to at least one embodiment of the present disclosure.

FIG. 34 is a conceptual diagram illustrating a merging example of the space region according to at least one embodiment of the present disclosure.

FIG. 35 is a conceptual diagram illustrating a merging example of the space region in a case of using a connection region according to at least one embodiment of the present disclosure.

FIG. 36 is a flowchart illustrating an example of the virtual store management process according to at least one embodiment of the present disclosure.

FIG. 37 is a conceptual diagram illustrating a merging example of the augmented reality diorama according to at least one embodiment of the present disclosure.

FIG. 38 is a conceptual diagram illustrating a merging example of the augmented reality diorama according to at least one embodiment of the present disclosure.

FIG. 39 is a conceptual diagram illustrating a merging example of the augmented reality diorama according to at least one embodiment of the present disclosure.

FIG. 40 is a flowchart illustrating an example of the virtual store management process according to at least one embodiment of the present disclosure.

FIG. 41 is a conceptual diagram illustrating an example of a matching process between the augmented reality diorama and the space region according to at least one embodiment of the present disclosure.

### DETAILED DESCRIPTION

Hereinafter, an example of embodiments of the present disclosure will be described with reference to the drawings. Various constituents in the example of each embodiment described below can be appropriately combined without contradiction or the like. In addition, contents described as an example of a certain embodiment may not be described in other embodiments. In addition, contents of operations or processes not related to a characteristic part of each embodiment may be omitted. Furthermore, an order of various processes constituting various flows or sequences described below may be changed without contradiction or the like in process contents.

### First Embodiment

A summary of a first embodiment of the present disclosure will be described. Hereinafter, a virtual store management program executed in a server will be illustratively described as the first embodiment.

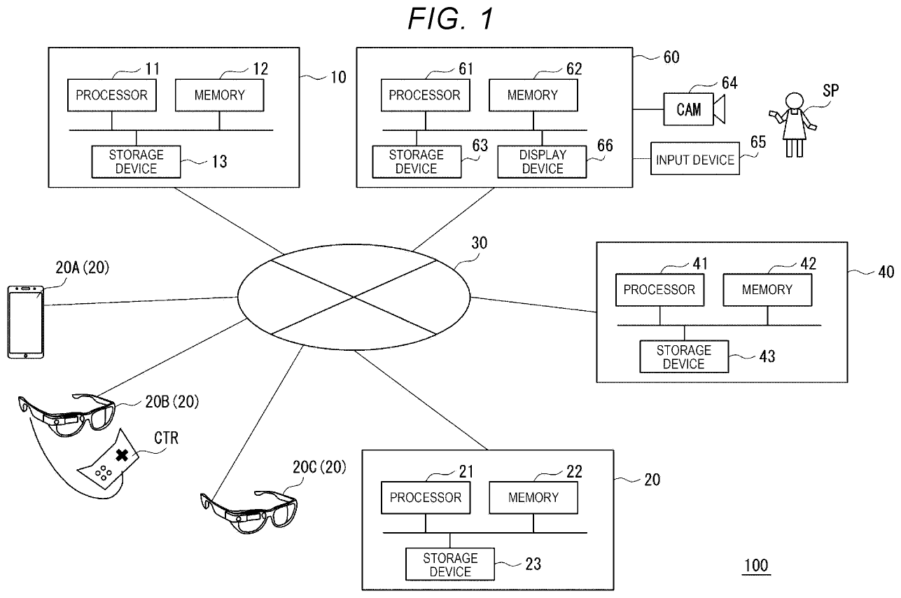

FIG. 1 is a diagram illustrating an example of a configuration of a virtual store management system according to at least one embodiment of the present disclosure. A virtual store management system 100 includes a virtual store management process server 10 (server 10) and a user terminal 20 used by a user of the virtual store management system 100. Each of user terminals 20A, 20B, and 20C is an example of the user terminal 20. The configuration of the virtual store management system 100 is not limited thereto. For example, the virtual store management system 100 may have a configuration in which a plurality of users use a single user terminal. The virtual store management system 100 may include a plurality of servers. For example, the virtual store management system 100 may further include another server 40.

The virtual store management system 100 may further include a receptionist apparatus 60. For example, a receptionist SP who serves a user visiting a virtual store uses the receptionist apparatus 60. Specific examples of the receptionist apparatus 60 include a server apparatus, a client apparatus, the user terminal described later, and the like.

Each of the server 10, the user terminal 20, the other server 40, and the receptionist apparatus 60 is communicably connected to a communication network 30 such as the Internet. Connection among the server 10, the user terminal 20, the other server 40, and the receptionist apparatus 60 through the communication network 30 may be wired connection or wireless connection. For example, a plurality of the user terminals 20 may be connected to the communication network 30 by performing data communication with a base station managed by a communication service provider using a wireless communication line.

The virtual store management system 100, by including the server 10 and the user terminal 20, implements various functions for executing various processes in accordance with an operation of the user.

The server 10 includes a processor 11, a memory 12, and a storage device 13. For example, the processor 11 is a central processing device such as a central processing unit (CPU) that performs various calculations and controls. In addition, in a case where the server 10 includes a graphics processing unit (GPU), the GPU may perform a part of the various calculations and controls. The server 10 executes various information processes by the processor 11 using data read into the memory 12 and stores obtained process results in the storage device 13 as needed.

The storage device 13 has a function as a storage medium storing various information. A configuration of the storage device 13 is not particularly limited but is preferably a configuration capable of storing all of various information necessary for controls performed in the virtual store management system 100 from a viewpoint of reducing a process load exerted on the user terminal 20. Such examples include a hard disk drive (HDD) and a solid state drive (SSD). However, the storage device storing various information may have a storage region in an accessible state from the server 10 and, for example, may be configured to have a dedicated storage region outside the server 10. The server 10 is managed by a manager or the like of the virtual store management system 100 and has various functions for providing information related to various processes to the plurality of user terminals 20. The server 10 is configured with an information processing apparatus such as a game server that can render augmented reality (AR) display data.

The user terminal 20 is configured with a communication terminal that can provide an information service accompanying AR display to the user. Examples of the communication terminal include, for example, a mobile phone terminal 20A such as a smartphone and AR glasses 20B and 20C. The communication terminal may be a stationary game apparatus, a portable game apparatus, a personal computer, a gaming PC, or a so-called wearable device, or a combination of a plurality of the communication terminals. The configuration of the user terminal that may be included in the virtual store management system 100 is not limited thereto and may be a configuration in which the user may visually recognize the AR display.

The user terminal 20 includes a processor 21, a memory 22, and a storage device 23. For example, the processor 21 is a central processing device such as a central processing unit (CPU) that performs various calculations and controls. In addition, in a case where the user terminal 20 includes a graphics processing unit (GPU), the GPU may perform a part of the various calculations and controls. The user terminal 20 executes various information processes by the processor 21 using data read into the memory 22 and stores obtained process results in the storage device 23 as needed. The storage device 23 has a function as a storage medium storing various information.

The user terminal 20 is connected to the communication network 30 and includes hardware and software for executing various processes by communicating with the server 10, the other server 40, or the receptionist apparatus 60. Each of the plurality of user terminals 20 may be configured to be capable of directly communicating with each other without the server 10, the other server 40, or the receptionist apparatus 60.

The user terminal 20 may incorporate a display device. The display device may be connected to the user terminal 20 in a wireless or wired manner. The display device displays images such as a still picture and a motion picture. The display device may display a game screen. The display device may display a shape of the receptionist SP based on data acquired directly from the receptionist apparatus 60 through the communication network 30 or further via the server 10 or the like. In addition, the display device can perform AR display superimposed on a real space. Examples of the display device include a hologram display device that can perform hologram display, and a projection device that projects images (including the game screen) to a screen or the like. In the example in FIG. 1, a touch panel screen included in the mobile phone terminal 20A, AR displays included in the AR glasses 20B and 20C, and the like correspond to the display device.

The user terminal 20 may incorporate an input device. In addition, the input device may be connected to the user terminal 20 in a wireless or wired manner. The input device receives an operation input provided by the user. The processor included in the server 10 or the processor included in the user terminal 20 executes various control processes in accordance with the operation input provided by the user. Examples of the input device include the touch panel screen included in the mobile phone terminal 20A, a controller CTR that is connected to the AR glasses 20B in a wireless or wired manner, and the like. In addition, a camera included in the user terminal 20 may correspond to the input device. The user provides the operation input (gesture input) by a gesture such as moving a hand in front of the camera.

Besides, the user terminal 20 may include another output device such as a speaker. The other output device outputs various information related to use of the virtual store to the user. For example, the output information includes a voice of the receptionist SP. The other output device may output voice information indicating a product purchased by the user or a content of a provided service received by the user. The other output device may output a sound (an in-store BGM or a sound generated in the store) in the virtual store. The other output device is not limited to a voice output device and may output other types of information. For example, in a case where the virtual store is a store dealing with perfumes, the other output device may output fragrance information. In a case where the virtual store is a store dealing with food, the other output device may output taste information. Besides, the other output device using haptic technology may output tactile information.

The other server 40 includes a processor 41, a memory 42, and a storage device 43. For example, the processor 41 is a central processing device such as a central processing unit (CPU) that performs various calculations and controls. In addition, in a case where the other server 40 includes a graphics processing unit (GPU), the GPU may perform a part of the various calculations and controls. The other server 40 executes various information processes by the processor 41 using data read into the memory 42 and stores obtained process results in the storage device 43 as needed.

The storage device 43 has a function as a storage medium storing various information. The configuration of the storage device 43 is not limited thereto. The storage device storing various information may have a storage region in an accessible state from the other server 40 and, for example, may be configured to have a dedicated storage region outside the other server 40. The other server 40 may be managed by the manager or the like of the virtual store management system 100 or may be managed by other persons. The other server 40 has various functions for providing information related to various processes to the plurality of user terminals 20. For example, the other server 40 may be a server that manages manufacturing and delivery of an actual article.

The receptionist apparatus 60 includes a processor 61, a memory 62, and a storage device 63. For example, the processor 61 is a central processing device such as a central processing unit (CPU) that performs various calculations and controls. In addition, in a case where the receptionist apparatus 60 includes a graphics processing unit (GPU), the GPU may perform a part of the various calculations and controls. The receptionist apparatus 60 executes various information processes by the processor 61 using data read into the memory 62 and stores obtained process results in the storage device 63 as needed. The storage device 63 has a function as a storage medium storing various information.

The receptionist apparatus 60 is connected to the communication network 30 and includes hardware and software for executing various processes by communicating with the server 10, the user terminal 20, or the other server 40.

The receptionist apparatus 60 includes a camera 64 and an input device 65. For example, the camera 64 images the receptionist SP who is a store clerk of the store. Captured image data in which the shape of the receptionist SP is captured is used by the receptionist SP in a cashier region, described later, included in the virtual store in order to serve the user in a case where the user purchases the product or the like at the virtual store. The input device 65 receives an operation input provided by the receptionist SP or the like. The processor 61 included in the receptionist apparatus 60 executes various control processes in accordance with the operation input provided by the receptionist SP or the like. Examples of the input device 65 include a keyboard, a mouse, and a microphone in a case of performing a voice operation. The camera 64 included in the receptionist apparatus 60 may also correspond to the input device. In this case, the receptionist SP provides the operation input (gesture input) using a gesture such as moving a hand in front of the camera 64.

The receptionist apparatus 60 includes a display device 66. The display device 66 may be incorporated in the receptionist apparatus 60. The display device 66 may be connected to the receptionist apparatus 60 in a wireless or wired manner. The display device 66 displays images such as a still picture and a motion picture. The display device 66 displays a shape of the user who purchases the product at the virtual store or receives provision of the service. The display device 66 may display information indicating a content of the product purchased by the user at the virtual store or a content of the provided service received by the user.

Besides, the receptionist apparatus 60 may include another output device such as a speaker. The other output device outputs information related to the user who uses the virtual store. For example, the information related to the user who uses the virtual store includes whether or not to purchase the product at the virtual store, and a voice of the user receiving provision of the service. The other output device may output the voice information indicating the product purchased by the user or the content of the provided service received by the user. The other output device may output a sound (an in-store BGM or a sound generated in the store) in the virtual store. The other output device is not limited to a voice output device and may output other types of information. For example, in a case where the virtual store is a store dealing with perfumes, the other output device may output fragrance information. In a case where the virtual store is a store selling food, the other output device may output taste information. Besides, the other output device using haptic technology may output tactile information.

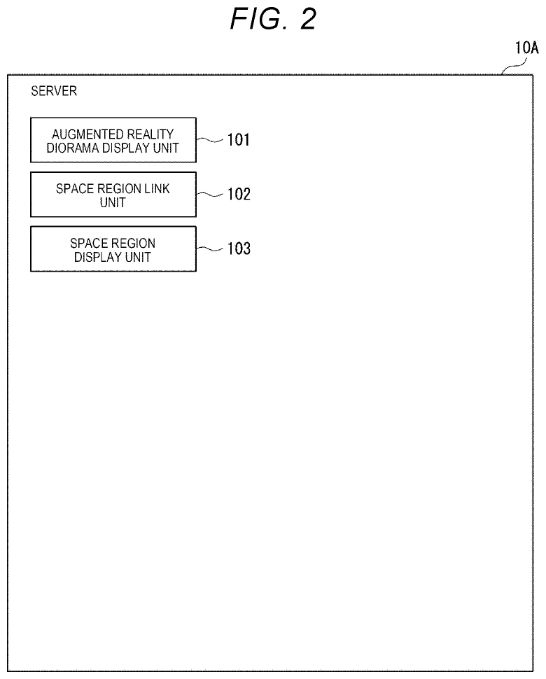

FIG. 2 is a block diagram illustrating a configuration of the server according to at least one embodiment of the present disclosure. A server 10A that is an example of the configuration of the server 10 includes at least an augmented reality diorama display unit 101, a space region link unit 102, and a space region display unit 103. The processor included in the server 10A functionally implements the augmented reality diorama display unit 101, the space region link unit 102, and the space region display unit 103 by referring to the virtual store management program held (installed) in the storage device and executing the program.

The augmented reality diorama display unit 101 has a function of displaying an augmented reality diorama superimposed on the real space on the display device. The space region link unit 102 has a function of linking one or more virtual space regions to the augmented reality diorama. The space region display unit 103 has a function of displaying the space region linked to the augmented reality diorama on the display device.

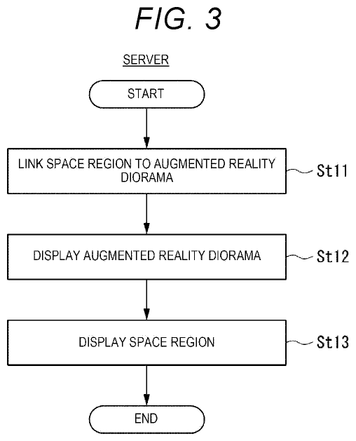

Next, a program execution process in the first embodiment of the present disclosure will be described. FIG. 3 is a flowchart illustrating an example of a virtual store management process according to at least one embodiment of the present disclosure.

The space region link unit 102 links one or more virtual space regions to the augmented reality diorama (St11). The augmented reality diorama display unit 101 displays the augmented reality diorama superimposed on the real space on the display device (St12). The space region display unit 103 displays the space region linked to the augmented reality diorama on the display device (St13).

The virtual space region is a region corresponding to the virtual store managed by the virtual store management program in a virtual space. For example, the virtual space may be a virtual three-dimensional coordinate space having an X axis, a Y axis, and a Z axis orthogonal to each other. However, the virtual space is not limited to the three-dimensional space and may be a two-dimensional space or the like depending on cases. The space region may be a closed space region such as an indoor store. The space region may be a space region that is not closed, such as an outdoor store or an event venue.

The real space means a space in a real world. The virtual space augmented from the real space means a virtual space (AR space) that can be output in a superimposed manner on the real space.

The virtual store means a virtual place in which products are sold to the user, or any services are provided. For example, a virtual representation of an actual store of a tailor shop using 3D data or a virtual representation, using 3D data, of an actual store of a vocal class in which singing is taught to the user corresponds to the virtual store. Types of products or services dealt at the virtual store are not limited to the above.

The augmented reality diorama means a virtual diorama output in a superimposed manner on the real space. Examples of the augmented reality diorama include a street, a road, a railway, a building, a group of buildings, a stadium of baseball, soccer, or the like, a shrine or a temple, a castle, a mountain, the sea, a river, a swamp, a grove, a forest, a field, a paddy field, an airport, an underground passage, a cave, and the like represented as 3D model data for the augmented reality (AR) display. The augmented reality diorama may not necessarily be based on a modern landscape that exists in the reality. Examples of the augmented reality diorama also include a medieval European streetscape or construction and a fictional streetscape or construction appearing in an animation, a comic book, or the like.

Linking the space region to the augmented reality diorama means associating the augmented reality diorama with the space region. For example, associating a second floor of a building included in the augmented reality diorama with the space region corresponding to the virtual store selling tailored clothes corresponds to linking here. In addition, associating a park included in the augmented reality diorama with a place (virtually represented live stage or the like) in which a live music video is played back corresponds to linking here.

Displaying the augmented reality diorama on the display device means outputting display data for displaying the augmented reality diorama in a superimposed manner on the real space to an apparatus (for example, the user terminal 20) including the display device or to the display device. In addition, displaying the augmented reality diorama on the display device may mean outputting an instruction for displaying the augmented reality diorama in a superimposed manner on the real space to an apparatus (for example, the user terminal 20 capable of generating or storing the display data) already having the display data or to the display device.

Displaying the space region on the display device means outputting display data for displaying the space region to the apparatus (for example, the user terminal 20) including the display device or to the display device. Displaying the space region on the display device may mean outputting an instruction for displaying the space region to the apparatus (for example, the user terminal 20 capable of generating or storing the display data) already having the display data or to the display device.

As an aspect of the first embodiment, the user can perform various transaction actions in a preferred virtual space. In addition, since the virtual store can be dynamically constructed in an associated state with the augmented reality diorama, the virtual space can be flexibly utilized in transaction.

### Second Embodiment

A summary of a second embodiment of the present disclosure will be described. Hereinafter, a virtual store management program executed in a server will be illustratively described as the second embodiment. The server may be the server 10 included in the virtual store management system 100 illustrated in FIG. 1.

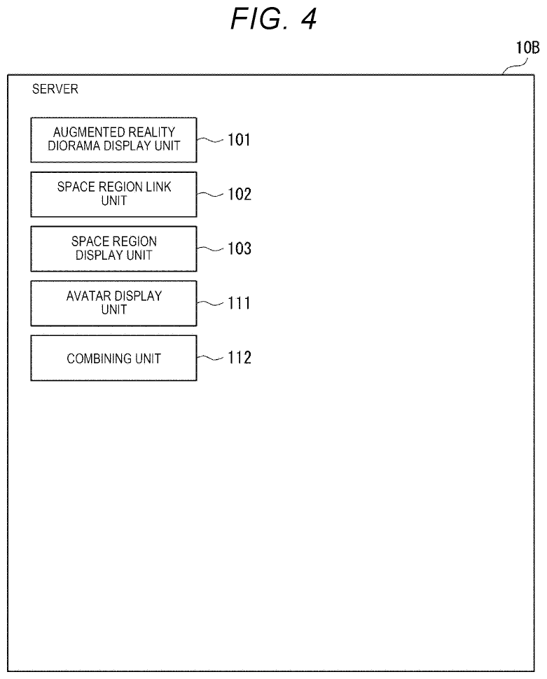

FIG. 4 is a block diagram illustrating a configuration of the server according to at least one embodiment of the present disclosure. A server 10B that is an example of the configuration of the server 10 includes at least the augmented reality diorama display unit 101, the space region link unit 102, the space region display unit 103, an avatar display unit 111, and a combining unit 112. The processor included in the server 10B functionally implements the augmented reality diorama display unit 101, the space region link unit 102, the space region display unit 103, the avatar display unit 111, and the combining unit 112 by referring to the virtual store management program held (installed) in the storage device and executing the program.

The augmented reality diorama display unit 101 has a function of displaying the augmented reality diorama superimposed on the real space on the display device. The space region link unit 102 has a function of linking one or more virtual space regions to the augmented reality diorama. The space region display unit 103 has a function of displaying the space region linked to the augmented reality diorama on the display device.

The avatar display unit 111 has a function of displaying a virtual avatar associated with the user on the display device together with the augmented reality diorama or the space region. The combining unit 112 has a function of combining an avatar with a virtual object having a predetermined correspondence relationship with the space region.

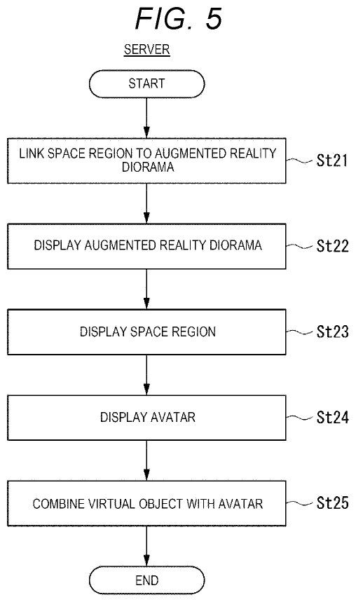

Next, a program execution process in the second embodiment of the present disclosure will be described. FIG. 5 is a flowchart illustrating an example of a virtual store management process according to at least one embodiment of the present disclosure.

The space region link unit 102 links one or more virtual space regions to the augmented reality diorama (St21). The augmented reality diorama display unit 101 displays the augmented reality diorama superimposed on the real space on the display device (St22). The space region display unit 103 displays the space region linked to the augmented reality diorama on the display device (St23).

The avatar display unit 111 displays the virtual avatar associated with the user on the display device together with the augmented reality diorama or the space region (St24). The combining unit 112 combines the avatar with the virtual object having the predetermined correspondence relationship with the space region (St25).

A meaning of each term related to steps St21 to St23 is the same as in the first embodiment and thus, will not be described.

The avatar means a character as an alter ego. The user can express an intention or perform an action by selecting an appearance of the character set by the user (or designated by the program or the like) in the virtual space. The appearance of the avatar may resemble an appearance of the user or may be different from the appearance of the user.

Displaying the avatar on the display device means outputting display data for displaying the avatar to the apparatus (for example, the user terminal 20) including the display device or to the display device. Displaying the avatar on the display device may mean outputting an instruction for displaying the avatar to the apparatus (for example, the user terminal 20 capable of generating or storing the display data) already having the display data or to the display device.

The virtual object means an object that can be output in the virtual space. Examples of the virtual object include a virtual representation of an article related to provision of the service or the product using 2D model data, 3D model data, or the like. Examples of the product include clothes, shoes, a backpack, a doll, a personal computer, a mobile phone, an automobile, a motorcycle, a ship, and the like. The product is not limited thereto and may be an article available for commercial transaction. The article related to provision of the service means an article related to the service such as a brush for coloring a nail or an artificial nail in a case where the service is for nail art.

Besides, examples of the virtual object include an item that can be output (for example, displayed) in the virtual space. For example, the item may be a sword, a shield, a helmet, an armor, a wand, clothes, an orb, a gun, a musical instrument, or a vehicle. The virtual object may be an animate object such as a bird, a cat, a dog, a dinosaur, grass, or a tree or a fictional animate object such as a dragon, as long as the virtual object is related to commercial transaction. For example, a form of service provision such as virtually showing a play in which a dragon appears at a movie theater that is the virtual store is considered. Besides, a building, a street, a continent or a planet, a star, a character appearing in a video game, and the like that are virtually represented may correspond to the virtual object here as long as the virtual representation is related to commercial transaction. The space region and the augmented reality diorama are also considered to be usable as a target of commercial transaction as data and thus, may correspond to the virtual object. These virtual objects may be held in a storage device included in the virtual store management system 100 or a storage device connectable to the virtual store management system 100 in a format of 2D model data, 3D model data, or the like.

For example, the predetermined correspondence relationship between the space region and the virtual object is a relationship such that the object is a virtual representation of the article related to provision of the service or the product of the store with respect to the space region that is the store.

Combining the virtual object with the avatar means using the object and the avatar together. For example, in a case where the object is virtual clothes, causing the avatar to wear (try on) the clothes corresponds to combining here. In a case where the object is a virtual automobile, causing the avatar to get in the automobile and drive (test-drive) based on a user operation corresponds to combining here. Besides, combining the virtual object with the avatar may have various aspects corresponding to types of objects.

As an aspect of the second embodiment, the user visiting the virtual store can try the product or the service in the virtual space before purchase using the avatar showing the alter ego or the like.

Particularly, in a case where a size of the avatar is set to the same size as the user, the user can try on the clothes in the virtual space. In a case where the size of the avatar is set to the same size as a friend of the user, the user can appreciate clothes and the like for a present for the friend in the virtual space. The same applies to other interpersonal relationships (a supervisor and a worker, a business client, and the like) other than friends. The user can try quality of the product or the service instead of another person.

### Third Embodiment

A summary of a third embodiment of the present disclosure will be described. Hereinafter, a virtual store management program executed in a server will be illustratively described as the third embodiment. The server may be the server 10 included in the virtual store management system 100 illustrated in FIG. 1.

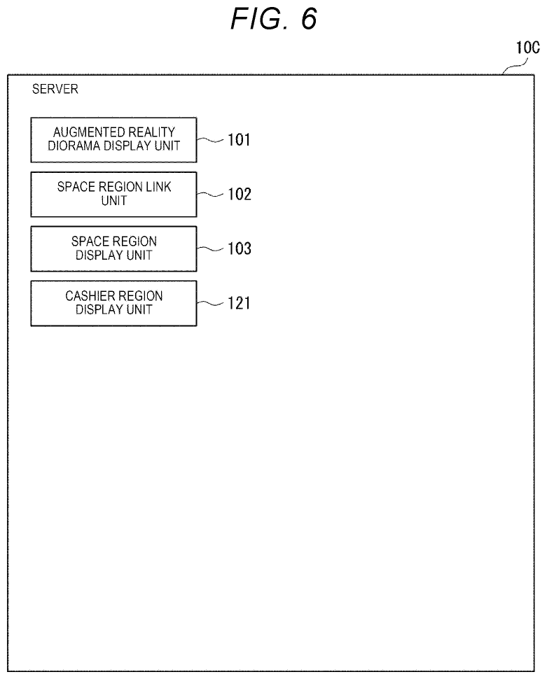

FIG. 6 is a block diagram illustrating a configuration of the server according to at least one embodiment of the present disclosure. A server 10C that is an example of the configuration of the server 10 includes at least the augmented reality diorama display unit 101, the space region link unit 102, the space region display unit 103, and a cashier region display unit 121. The processor included in the server 10C functionally implements the augmented reality diorama display unit 101, the space region link unit 102, the space region display unit 103, and the cashier region display unit 121 by referring to the virtual store management program held (installed) in the storage device and executing the program.

The augmented reality diorama display unit 101 has a function of displaying the augmented reality diorama superimposed on the real space on the display device. The space region link unit 102 has a function of linking one or more virtual space regions to the augmented reality diorama. The space region display unit 103 has a function of displaying the space region linked to the augmented reality diorama on the display device. The cashier region display unit 121 has a function of displaying the virtual cashier region for causing the user to acquire a predetermined permission for the virtual object having the predetermined correspondence relationship with the space region or an object corresponding to the virtual object in the real space, on the display device in association with the space region.

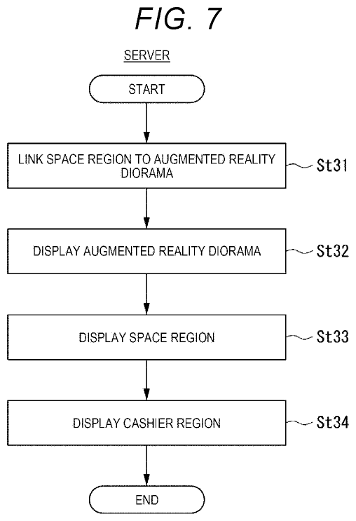

Next, a program execution process in the third embodiment of the present disclosure will be described. FIG. 7 is a flowchart illustrating an example of a virtual store management process according to at least one embodiment of the present disclosure.

The space region link unit 102 links one or more virtual space regions to the augmented reality diorama (St31). The augmented reality diorama display unit 101 displays the augmented reality diorama superimposed on the real space on the display device (St32). The space region display unit 103 displays the space region linked to the augmented reality diorama on the display device (St33).

The cashier region display unit 121 displays the virtual cashier region for causing the user to acquire the predetermined permission for the virtual object having the predetermined correspondence relationship with the space region or the object corresponding to the virtual object in the real space, on the display device in association with the space region (St34).

The virtual cashier region for causing the user to acquire the predetermined permission for the virtual object having the predetermined correspondence relationship with the space region or the object corresponding to the virtual object in the real space is displayed on the display device in association with the space region (St34).

A meaning of each term related to steps St31 to St33 and a meaning of the virtual object having the predetermined correspondence relationship with the space region are the same as in the second embodiment and thus, will not be described.

The predetermined permission means various permissions that can be acquired by the user for an object in the real space or the virtual space. For example, for the object in the real space, a permission to possess the object by purchase, a permission to use the object by receiving a license of use, a permission to be capable of temporarily managing the object by renting, and a permission to transfer or lease the object by obtaining a license of transfer or lease to another person correspond to the permission here. For the object in the virtual space, for example, a permission to use the object for a certain period or indefinitely by paying, a permission to copy the object by obtaining a license of copying, and a permission to transfer or lease the object to another user by obtaining a license of transfer or lease to another person correspond to the permission here. A permission to, for example, modify, enlarge, reduce, unify, develop, degenerate the object by obtaining a license may also correspond to the permission here.

The virtual cashier region means a region displayed in the virtual space in order to cause the user to acquire the permission. For example, a virtual representation of a cashier counter in a real store using 2D or 3D modeling data or the like is an example of the cashier region. The cashier region may be a region in which the user pays a price (money, points, or the like) for acquiring the permission in the cashier region, or may be a region in which the price is not paid as in a case of, for example, free transfer.

Displaying the virtual cashier region on the display device means outputting display data for displaying the virtual cashier region to the apparatus (for example, the user terminal 20) including the display device or to the display device. Displaying the virtual cashier region on the display device may mean outputting an instruction for displaying the virtual cashier region to the apparatus (for example, the user terminal 20 capable of generating or storing the display data) already having the display data or to the display device. For example, displaying the virtual cashier region on the display device in association with the space region means displaying the virtual cashier region at a position having a predetermined relationship with the space region, such as in or near the space region corresponding to the virtual store.

As an aspect of the third embodiment, for example, the user visiting the virtual store can receive various types of convenience such as purchasing the product and obtaining the permission for use in the virtual space. In a case where the user pays the price for acquiring the permission, the user can perform commercial transaction or settlement in the cashier region.

### Fourth Embodiment

A summary of a fourth embodiment of the present disclosure will be described. Hereinafter, a virtual store management program executed in a server will be illustratively described as the fourth embodiment. The server may be the server 10 included in the virtual store management system 100 illustrated in FIG. 1.

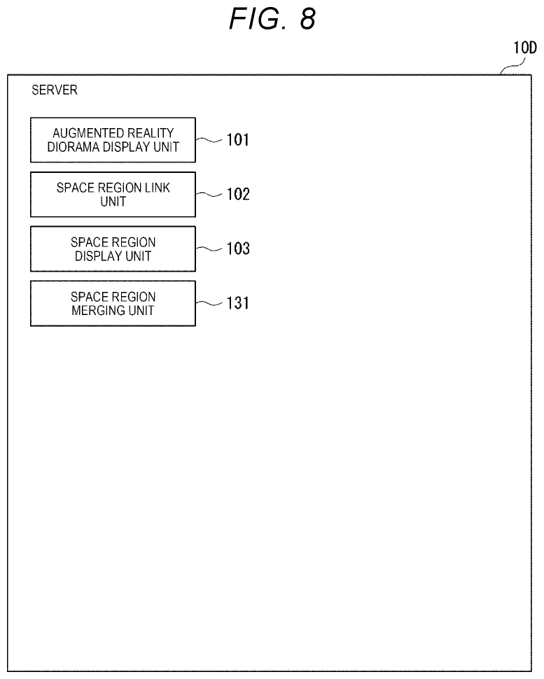

FIG. 8 is a block diagram illustrating a configuration of the server according to at least one embodiment of the present disclosure. A server 10D that is an example of the configuration of the server 10 includes at least the augmented reality diorama display unit 101, the space region link unit 102, the space region display unit 103, and a space region merging unit 131. The processor included in the server 10D functionally implements the augmented reality diorama display unit 101, the space region link unit 102, the space region display unit 103, and the space region merging unit 131 by referring to the virtual store management program held (installed) in the storage device and executing the program.

The augmented reality diorama display unit 101 has a function of displaying the augmented reality diorama superimposed on the real space on the display device. The space region link unit 102 has a function of linking one or more virtual space regions to the augmented reality diorama. The space region display unit 103 has a function of displaying the space region linked to the augmented reality diorama on the display device. The space region merging unit 131 has a function of merging two or more space regions.

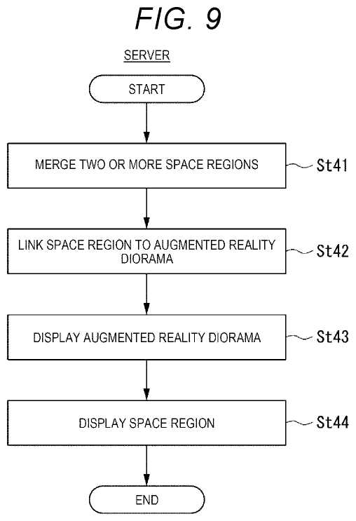

Next, a program execution process in the fourth embodiment of the present disclosure will be described. FIG. 9 is a flowchart illustrating an example of a virtual store management process according to at least one embodiment of the present disclosure.

The space region merging unit 131 merges two or more space regions (St41). The space region link unit 102 links one or more virtual space regions to the augmented reality diorama (St42). The augmented reality diorama display unit 101 displays the augmented reality diorama superimposed on the real space on the display device (St43). The space region display unit 103 displays the space region linked to the augmented reality diorama on the display device (St44).

A meaning of each term related to steps St42 to St44 is the same as in the first to third embodiments and thus, will not be described.

For example, merging two or more space regions means integrating a plurality of space regions as in a case of connecting a space region corresponding to a virtual store selling tailored clothes to a space region corresponding to a virtual store selling shoes.

As an aspect of the fourth embodiment, the space region corresponding to the store can be dynamically merged. Thus, a virtual complex store or a virtual shopping mall can be flexibly constructed in accordance with needs of the user. The user can perform transaction at the virtual complex store or the virtual shopping mall that matches a preference of the user.

In addition, in a case where the user acquires a permission to control the space region merging unit 131, the user can construct or customize a desired virtual complex store or virtual shopping mall. Accordingly, the user or another person (a friend, a family member, a viewer of a motion picture posted on a motion picture posting site by the user, a person connected on an SNS, or the like) having a predetermined relationship with the user can visit a plurality of virtual stores arranged as desired by the user and perform transaction.

### Fifth Embodiment

A summary of a fifth embodiment of the present disclosure will be described. Hereinafter, a virtual store management program executed in a server will be illustratively described as the fifth embodiment. The server may be the server 10 included in the virtual store management system 100 illustrated in FIG. 1.

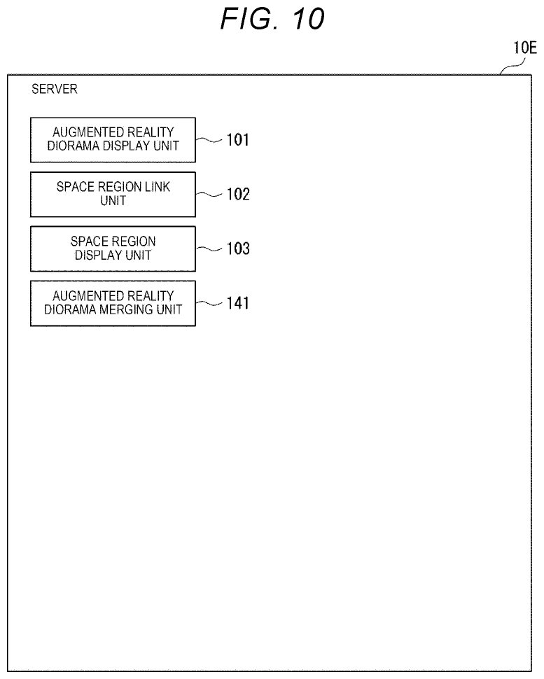

FIG. 10 is a block diagram illustrating a configuration of the server according to at least one embodiment of the present disclosure. A server 10E that is an example of the configuration of the server 10 includes at least the augmented reality diorama display unit 101, the space region link unit 102, the space region display unit 103, and an augmented reality diorama merging unit 141. The processor included in the server 10E functionally implements the augmented reality diorama display unit 101, the space region link unit 102, the space region display unit 103, and the augmented reality diorama merging unit 141 by referring to the virtual store management program held (installed) in the storage device and executing the program.

The augmented reality diorama display unit 101 has a function of displaying the augmented reality diorama superimposed on the real space on the display device. The space region link unit 102 has a function of linking one or more virtual space regions to the augmented reality diorama. The space region display unit 103 has a function of displaying the space region linked to the augmented reality diorama on the display device. The augmented reality diorama merging unit 141 has a function of merging two or more augmented reality dioramas.

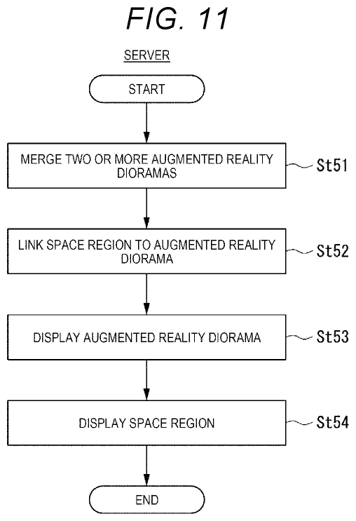

Next, a program execution process in the fifth embodiment of the present disclosure will be described. FIG. 11 is a flowchart illustrating an example of a virtual store management process according to at least one embodiment of the present disclosure.

The augmented reality diorama merging unit 141 merges two or more augmented reality dioramas (St51). The space region link unit 102 links one or more virtual space regions to the augmented reality diorama (St52). The augmented reality diorama display unit 101 displays the augmented reality diorama superimposed on the real space on the display device (St53). The space region display unit 103 displays the space region linked to the augmented reality diorama on the display device (St54).

A meaning of each term related to steps St52 to St54 is the same as in the first to fourth embodiments and thus, will not be described.

For example, merging two or more augmented reality dioramas means integrating a plurality of augmented reality dioramas as in a case of connecting an augmented reality diorama reproducing a streetscape of Akihabara to an augmented reality diorama reproducing a streetscape of Ikebukuro. The plurality of augmented reality dioramas as a merging target may not be adjacent to each other in the real world. In addition, the augmented reality diorama merging unit 141 may merge an augmented reality diorama resembling the real world with an augmented reality diorama resembling a virtual world (for example, a fictional street appearing in a comic book). The augmented reality diorama merging unit 141 may merge a plurality of augmented reality dioramas resembling the virtual world.

As an aspect of the fifth embodiment, by merging a plurality of augmented reality dioramas resembling different places, a free streetscape that overcomes geographical restrictions in the real world can be reproduced in the AR space. Furthermore, the user can perform more flexible and free transaction by using the virtual store (space region) arranged in the streetscape overcoming the geographical restrictions in the real world.

In addition, in a case where the user acquires a permission to control the augmented reality diorama merging unit 141, the user can construct a new augmented reality diorama by merging desired augmented reality dioramas. Accordingly, the user or another person (a friend, a family member, a viewer of a motion picture posted on a motion picture posting site by the user, a person connected on an SNS, or the like) having a predetermined relationship with the user can perform transaction at a plurality of virtual stores arranged in the augmented reality diorama constructed as desired by the user.

Furthermore, since an augmented reality diorama constructed by a first person can be merged with an augmented reality diorama constructed by a second person, a highly creative augmented reality diorama can be constructed by collaboration between both of the first person and the second person. The user can perform transaction at a plurality of virtual stores arranged in the augmented reality diorama constructed by collaboration between a plurality of persons.

The present disclosure is not limited to the fifth embodiment. An entity that, for example, constructs, improves, merges, or separates the augmented reality diorama may be a businessperson operating the store or may be a general user. For example, the entity may be a person who posts contents on a posting site dealing with contents such as a motion picture and a virtual reality diorama, or a user of a social networking service (SNS).

### Sixth Embodiment

A summary of a sixth embodiment of the present disclosure will be described. Hereinafter, a virtual store management program executed in a server will be illustratively described as the sixth embodiment. The server may be the server 10 included in the virtual store management system 100 illustrated in FIG. 1.

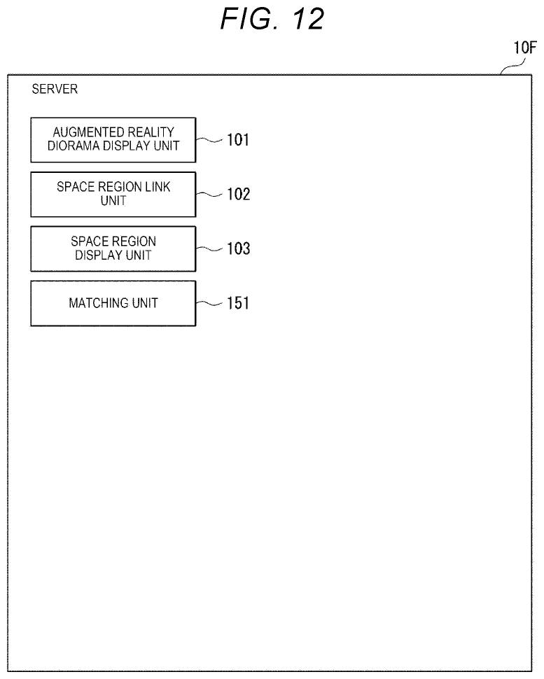

FIG. 12 is a block diagram illustrating a configuration of the server according to at least one embodiment of the present disclosure. A server 10F that is an example of the configuration of the server 10 includes at least the augmented reality diorama display unit 101, the space region link unit 102, the space region display unit 103, and a matching unit 151. The processor included in the server 10F functionally implements the augmented reality diorama display unit 101, the space region link unit 102, the space region display unit 103, and the matching unit 151 by referring to the virtual store management program held (installed) in the storage device and executing the program.

The augmented reality diorama display unit 101 has a function of displaying the augmented reality diorama superimposed on the real space on the display device. The space region link unit 102 has a function of linking one or more virtual space regions to the augmented reality diorama. The space region display unit 103 has a function of displaying the space region linked to the augmented reality diorama on the display device. The matching unit 151 has a function of matching the augmented reality diorama with the space region.

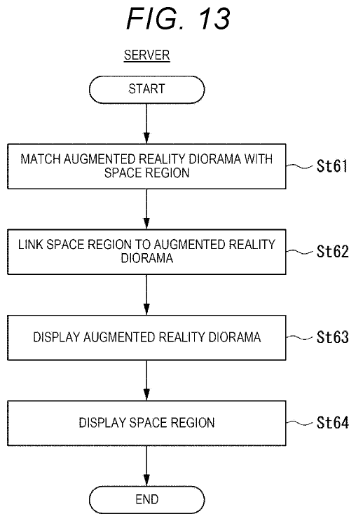

Next, a program execution process in the sixth embodiment of the present disclosure will be described. FIG. 13 is a flowchart illustrating an example of a virtual store management process according to at least one embodiment of the present disclosure.

The matching unit 151 matches the augmented reality diorama with the space region (St61). The space region link unit 102 links one or more virtual space regions to the augmented reality diorama (St62). The augmented reality diorama display unit 101 displays the augmented reality diorama superimposed on the real space on the display device (St63). The space region display unit 103 displays the space region linked to the augmented reality diorama on the display device (St64).

A meaning of each term related to steps St62 to St64 is the same as in the first to fifth embodiments and thus, will not be described.

Matching the augmented reality diorama with the space region means selecting the augmented reality diorama and the space region as a target of linking in step St62. For example, selecting a space region linkable to a predetermined augmented reality diorama from a plurality of space regions corresponds to matching. In addition, selecting an augmented reality diorama linkable to a predetermined space region from a plurality of augmented reality dioramas corresponds to matching. Selecting a space region and an augmented reality diorama linkable to each other based on any standard (a year, a location, attribute information of the user, or the like) or a theme (tastes of autumn, places or objects for health, or the like) also corresponds to matching. For example, the attribute information of the user may be a product of a high possibility of purchase speculated from information such as a sex, an age, a birthplace, an address, and a purchase history of the user, but is not limited thereto.

As an aspect of the sixth embodiment, for example, the space region and/or the augmented reality diorama of the target of linking can be found from multiple space regions and/or augmented reality dioramas registered in the storage device in accordance with a predetermined standard.

### Seventh Embodiment

A summary of a seventh embodiment of the present disclosure will be described. Hereinafter, a virtual store management system will be illustratively described as the seventh embodiment.

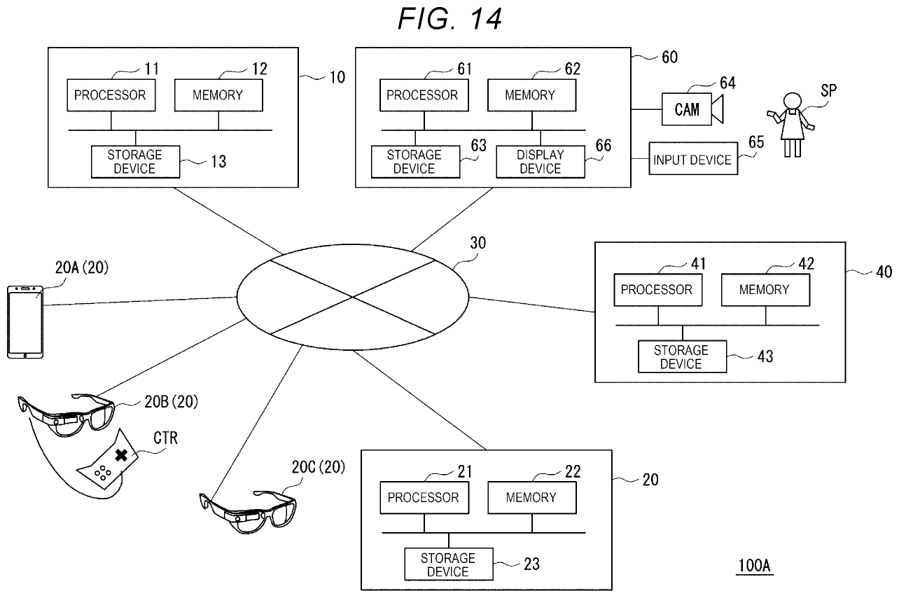

FIG. 14 is a diagram illustrating an example of a configuration of the virtual store management system according to at least one embodiment of the present disclosure. A virtual store management system 100A includes the virtual store management process server 10 (server 10) and the user terminal 20 used by a user of the virtual store management system 100A. Each of the user terminals 20A, 20B, and 20C is an example of the user terminal 20. The configuration of the virtual store management system 100A is not limited thereto. For example, the virtual store management system 100A may have a configuration in which a plurality of users use a single user terminal. The virtual store management system 100A may include a plurality of servers. For example, the virtual store management system 100A may further include the other server 40.

The virtual store management system 100A may further include the receptionist apparatus 60. For example, the receptionist SP who serves the user visiting the virtual store uses the receptionist apparatus 60. Specific examples of the receptionist apparatus 60 include a server apparatus, a client apparatus, the user terminal, and the like.

Each of the server 10, the user terminal 20, the other server 40, and the receptionist apparatus 60 is communicably connected to the communication network 30 such as the Internet. Connection among the server 10, the user terminal 20, the other server 40, and the receptionist apparatus 60 through the communication network 30 may be wired connection or wireless connection. For example, the plurality of user terminals 20 may be connected to the communication network 30 by performing data communication with the base station managed by the communication service provider using the wireless communication line.

The virtual store management system 100A, by including the server 10 and the user terminal 20, implements various functions for executing various processes in accordance with the operation of the user.

The server 10 includes the processor 11, the memory 12, and the storage device 13. For example, the processor 11 is a central processing device such as a central processing unit (CPU) that performs various calculations and controls. In addition, in a case where the server 10 includes a graphics processing unit (GPU), the GPU may perform a part of the various calculations and controls. The server 10 executes various information processes by the processor 11 using data read into the memory 12 and stores obtained process results in the storage device 13 as needed.

The storage device 13 has a function as a storage medium storing various information. A configuration of the storage device 13 is not particularly limited but is preferably a configuration capable of storing all of various information necessary for controls performed in the virtual store management system 100A from the viewpoint of reducing the process load exerted on the user terminal 20. Such examples include an HDD and an SSD. However, the storage device storing various information may have a storage region in an accessible state from the server 10 and, for example, may be configured to have a dedicated storage region outside the server 10. The server 10 is managed by a manager or the like of the virtual store management system 100A and has various functions for providing information related to various processes to the plurality of user terminals 20. The server 10 is configured with an information processing apparatus such as a game server that can render AR display data.

The user terminal 20 is configured with a communication terminal that can provide an information service accompanying AR display to the user. Examples of the communication terminal include, for example, a mobile phone terminal 20A such as a smartphone and AR glasses 20B and 20C. The communication terminal may be a stationary game apparatus, a portable game apparatus, a personal computer, a gaming PC, or a so-called wearable device, or a combination of a plurality of the communication terminals. The configuration of the user terminal that may be included in the virtual store management system 100A is not limited thereto and may be a configuration in which the user may visually recognize the AR display.

The user terminal 20 includes a processor 21, a memory 22, and a storage device 23. For example, the processor 21 is a central processing device such as a central processing unit (CPU) that performs various calculations and controls. In addition, in a case where the user terminal 20 includes a graphics processing unit (GPU), the GPU may perform a part of the various calculations and controls. The user terminal 20 executes various information processes by the processor 21 using data read into the memory 22 and stores obtained process results in the storage device 23 as needed. The storage device 23 has a function as a storage medium storing various information.

The user terminal 20 is connected to the communication network 30 and includes hardware and software for executing various processes by communicating with the server 10, the other server 40, or the receptionist apparatus 60. Each of the plurality of user terminals 20 may be configured to be capable of directly communicating with each other without the server 10, the other server 40, or the receptionist apparatus 60.

The user terminal 20 may incorporate a display device. The display device may be connected to the user terminal 20 in a wireless or wired manner. The display device displays images such as a still picture and a motion picture. The display device may display a game screen. The display device may display the shape of the receptionist SP based on data acquired directly from the receptionist apparatus 60 through the communication network 30 or further via the server 10 or the like. In addition, the display device can perform the augmented reality (AR) display superimposed on the real space. Examples of the display device include a hologram display device that can perform hologram display, and a projection device that projects images (including the game screen) to a screen or the like. In the example in FIG. 14, the touch panel screen included in the mobile phone terminal 20A, the AR displays included in the AR glasses 20B and 20C, and the like correspond to the display device.

The user terminal 20 may incorporate an input device. In addition, the input device may be connected to the user terminal 20 in a wireless or wired manner. The input device receives an operation input provided by the user. The processor included in the server 10 or the processor included in the user terminal 20 executes various control processes in accordance with the operation input provided by the user. Examples of the input device include the touch panel screen included in the mobile phone terminal 20A, the controller CTR that is connected to the AR glasses 20B in a wireless or wired manner, and the like. In addition, the camera included in the user terminal 20 may correspond to the input device. The user provides the operation input (gesture input) by a gesture such as moving a hand in front of the camera.

Besides, the user terminal 20 may include another output device such as a speaker. The other output device outputs various information related to use of the virtual store to the user. For example, the output information includes the voice of the receptionist SR The other output device may output voice information indicating the product purchased by the user or the content of the provided service received by the user. The other output device may output a sound (an in-store BGM or a sound generated in the store) in the virtual store. The other output device is not limited to a voice output device and may output other types of information. For example, in a case where the virtual store is a store dealing with perfumes, the other output device may output fragrance information. In a case where the virtual store is a store dealing with food, the other output device may output taste information. Besides, the other output device using haptic technology may output tactile information.

The other server 40 includes the processor 41, the memory 42, and the storage device 43. For example, the processor 41 is a central processing device such as a central processing unit (CPU) that performs various calculations and controls. In addition, in a case where the other server 40 includes a graphics processing unit (GPU), the GPU may perform a part of the various calculations and controls. The other server 40 executes various information processes by the processor 41 using data read into the memory 42 and stores obtained process results in the storage device 43 as needed.

The storage device 43 has a function as a storage medium storing various information. The configuration of the storage device 43 is not limited thereto. The storage device storing various information may have a storage region in an accessible state from the other server 40 and, for example, may be configured to have a dedicated storage region outside the other server 40. The other server 40 may be managed by the manager or the like of the virtual store management system 100A or may be managed by other persons. The other server 40 has various functions for providing information related to various processes to the plurality of user terminals 20. For example, the other server 40 may be a server that manages manufacturing and delivery of the actual article.

The receptionist apparatus 60 includes the processor 61, the memory 62, and the storage device 63. For example, the processor 61 is a central processing device such as a central processing unit (CPU) that performs various calculations and controls. In addition, in a case where the receptionist apparatus 60 includes a graphics processing unit (GPU), the GPU may perform a part of the various calculations and controls. The receptionist apparatus 60 executes various information processes by the processor 61 using data read into the memory 62 and stores obtained process results in the storage device 63 as needed. The storage device 63 has a function as a storage medium storing various information.

The receptionist apparatus 60 is connected to the communication network 30 and includes hardware and software for executing various processes by communicating with the server 10, the user terminal 20, or the other server 40.

The receptionist apparatus 60 includes the camera 64 and the input device 65. For example, the camera 64 images the receptionist SP who is a store clerk of the store. The captured image data in which the shape of the receptionist SP is captured is used by the receptionist SP in the cashier region, described later, included in the virtual store in order to serve the user in a case where the user purchases the product or the like at the virtual store. The input device 65 receives the operation input provided by the receptionist SP or the like. The processor 61 included in the receptionist apparatus 60 executes various control processes in accordance with the operation input provided by the receptionist SP or the like. Examples of the input device 65 include a keyboard, a mouse, and a microphone in a case of performing a voice operation. The camera 64 included in the receptionist apparatus 60 may also correspond to the input device. In this case, the receptionist SP provides the operation input (gesture input) using a gesture such as moving a hand in front of the camera 64.

The receptionist apparatus 60 includes the display device 66. The display device 66 may be incorporated in the receptionist apparatus 60. The display device 66 may be connected to the receptionist apparatus 60 in a wireless or wired manner. The display device 66 displays images such as a still picture and a motion picture. The display device 66 displays the shape of the user who purchases the product at the virtual store or receives provision of the service. The display device 66 may display information indicating the content of the product purchased by the user at the virtual store or the content of the provided service received by the user.

Besides, the receptionist apparatus 60 may include another output device such as a speaker. The other output device outputs information related to the user who uses the virtual store. For example, the information related to the user who uses the virtual store includes whether or not to purchase the product at the virtual store, and the voice of the user receiving provision of the service. The other output device may output voice information indicating the product purchased by the user or the content of the provided service received by the user. The other output device may output a sound (an in-store BGM or a sound generated in the store) in the virtual store. The other output device is not limited to a voice output device and may output other types of information. For example, in a case where the virtual store is a store dealing with perfumes, the other output device may output fragrance information. In a case where the virtual store is a store selling food, the other output device may output taste information. Besides, the other output device using haptic technology may output tactile information.

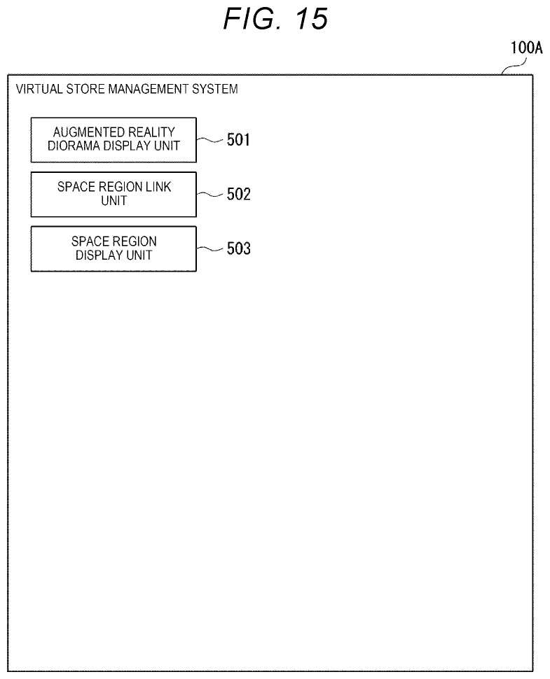

FIG. 15 is a block diagram illustrating the configuration of the virtual store management system according to at least one embodiment of the present disclosure. The virtual store management system 100A includes at least an augmented reality diorama display unit 501, a space region link unit 502, and a space region display unit 503. One or more processors included in the virtual store management system 100A functionally implement the augmented reality diorama display unit 501, the space region link unit 502, and the space region display unit 503 by referring to a virtual store management program held (installed) in one or more storage devices included in the virtual store management system 100A and executing the program.

The augmented reality diorama display unit 501 has a function of displaying the augmented reality diorama superimposed on the real space on the display device. The space region link unit 502 has a function of linking one or more virtual space regions to the augmented reality diorama. The space region display unit 503 has a function of displaying the space region linked to the augmented reality diorama on the display device.

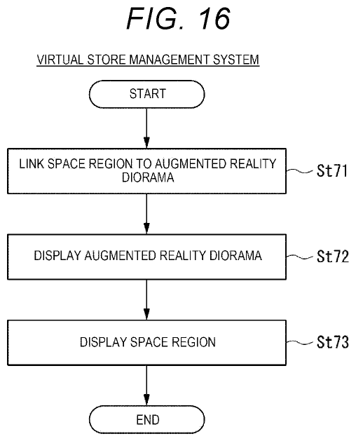

Next, a program execution process in the seventh embodiment of the present disclosure will be described. FIG. 16 is a flowchart illustrating an example of a virtual store management process according to at least one embodiment of the present disclosure.

The space region link unit 502 links one or more virtual space regions to the augmented reality diorama (St71). The augmented reality diorama display unit 501 displays the augmented reality diorama superimposed on the real space on the display device (St72). The space region display unit 503 displays the space region linked to the augmented reality diorama on the display device (St73).

The virtual space region is a region corresponding to the virtual store managed by the virtual store management program in the virtual space. For example, the virtual space may be a virtual three-dimensional coordinate space having an X axis, a Y axis, and a Z axis orthogonal to each other. However, the virtual space is not limited to the three-dimensional space and may be a two-dimensional space or the like depending on cases. The space region may be a closed space region such as an indoor store. The space region may be a space region that is not closed, such as an outdoor store or an event venue.

The real space means a space in the real world. The virtual space augmented from the real space means a virtual space (AR space) that can be output in a superimposed manner on the real space.

The virtual store means a virtual place in which products are sold to the user, or any services are provided. For example, a virtual representation of an actual store of a tailor shop using 3D data or a virtual representation, using 3D data, of an actual store of a vocal class in which singing is taught to the user corresponds to the virtual store. Types of products or services dealt at the virtual store are not limited to the above.

The augmented reality diorama means a virtual diorama output in a superimposed manner on the real space. Examples of the augmented reality diorama include a street, a road, a railway, a building, a group of buildings, a stadium of baseball, soccer, or the like, a shrine or a temple, a castle, a mountain, the sea, a river, a swamp, a grove, a forest, a field, a paddy field, an airport, an underground passage, a cave, and the like represented as 3D model data for the augmented reality (AR) display. The augmented reality diorama may not necessarily be based on a modern landscape that exists in the reality. Examples of the augmented reality diorama also include a medieval European streetscape or construction and a fictional streetscape or construction appearing in an animation, a comic book, or the like.

Linking the space region to the augmented reality diorama means associating the augmented reality diorama with the space region. For example, associating a second floor of a building included in the augmented reality diorama with the space region corresponding to the virtual store selling tailored clothes corresponds to linking here. In addition, associating a park included in the augmented reality diorama with a place (virtually represented live stage or the like) in which a live music video is played back corresponds to linking here.

Displaying the augmented reality diorama on the display device means outputting display data for displaying the augmented reality diorama in a superimposed manner on the real space to an apparatus (for example, the user terminal 20) including the display device or to the display device. In addition, displaying the augmented reality diorama on the display device may mean outputting an instruction for displaying the augmented reality diorama in a superimposed manner on the real space to the apparatus (for example, the user terminal 20 capable of generating or storing the display data) already having the display data or to the display device. An entity that performs a process of displaying the augmented reality diorama on the display device, and the apparatus including the display device may be the same apparatus.

Displaying the space region on the display device means outputting display data for displaying the space region to the apparatus (for example, the user terminal 20) including the display device or to the display device. Displaying the space region on the display device may mean outputting an instruction for displaying the space region to the apparatus (for example, the user terminal 20 capable of generating or storing the display data) already having the display data or to the display device. An entity that performs a process of displaying the space region on the display device, and the apparatus including the display device may be the same apparatus.

As an aspect of the seventh embodiment, the user can perform various transaction actions in a preferred virtual space. In addition, since the virtual store can be dynamically constructed in an associated state with the augmented reality diorama, the virtual space can be flexibly utilized in transaction.

### Eighth Embodiment

A summary of an eighth embodiment of the present disclosure will be described. Hereinafter, a virtual store management program executed in a user terminal will be illustratively described as the eighth embodiment. A user terminal 20Z may be any of the plurality of user terminals 20 and 20A to 20C illustrated in FIG. 1 or FIG. 14.

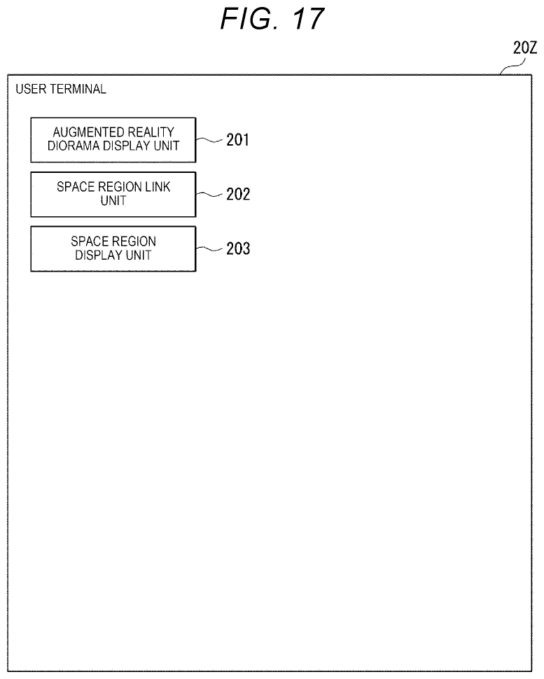

FIG. 17 is a block diagram illustrating a configuration of the user terminal according to at least one embodiment of the present disclosure. The user terminal 20Z that is an example of the configuration of the user terminal 20 includes at least an augmented reality diorama display unit 201, a space region link unit 202, and a space region display unit 203. The processor included in the user terminal 20Z functionally implements the augmented reality diorama display unit 201, the space region link unit 202, and the space region display unit 203 by referring to the virtual store management program held (installed) in the storage device and executing the program.

The augmented reality diorama display unit 201 has a function of displaying the augmented reality diorama superimposed on the real space on the display device. The space region link unit 202 has a function of linking one or more virtual space regions to the augmented reality diorama. The space region display unit 203 has a function of displaying the space region linked to the augmented reality diorama on the display device.

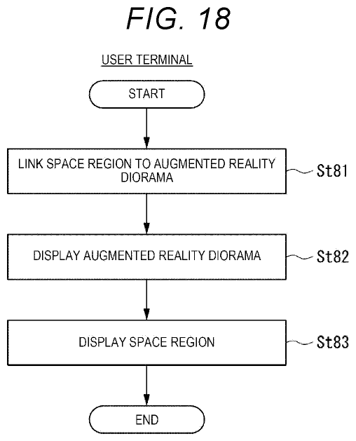

Next, a program execution process in the eighth embodiment of the present disclosure will be described. FIG. 18 is a flowchart illustrating an example of a virtual store management process according to at least one embodiment of the present disclosure.

The space region link unit 202 links one or more virtual space regions to the augmented reality diorama (St81). The augmented reality diorama display unit 201 displays the augmented reality diorama superimposed on the real space on the display device (St82). The space region display unit 203 displays the space region linked to the augmented reality diorama on the display device (St83).

The virtual space region is a region corresponding to the virtual store managed by the virtual store management program in the virtual space. For example, the virtual space may be a virtual three-dimensional coordinate space having an X axis, a Y axis, and a Z axis orthogonal to each other. However, the virtual space is not limited to the three-dimensional space and may be a two-dimensional space or the like depending on cases. The space region may be a closed space region such as an indoor store. The space region may be a space region that is not closed, such as an outdoor store or an event venue.

The real space means a space in the real world. The virtual space augmented from the real space means a virtual space (AR space) that can be output in a superimposed manner on the real space.

The virtual store means a virtual place in which products are sold to the user, or any services are provided. For example, a virtual representation of an actual store of a tailor shop using 3D data or a virtual representation, using 3D data, of an actual store of a vocal class in which singing is taught to the user corresponds to the virtual store. Types of products or services dealt at the virtual store are not limited to the above.

The augmented reality diorama means a virtual diorama output in a superimposed manner on the real space. Examples of the augmented reality diorama include a street, a road, a railway, a building, a group of buildings, a stadium of baseball, soccer, or the like, a shrine or a temple, a castle, a mountain, the sea, a river, a swamp, a grove, a forest, a field, a paddy field, an airport, an underground passage, a cave, and the like represented as 3D model data for the augmented reality (AR) display. The augmented reality diorama may not necessarily be based on a modern landscape that exists in the reality. Examples of the augmented reality diorama also include a medieval European streetscape or construction and a fictional streetscape or construction appearing in an animation, a comic book, or the like.

Linking the space region to the augmented reality diorama means associating the augmented reality diorama with the space region. For example, associating a second floor of a building included in the augmented reality diorama with the space region corresponding to the virtual store selling tailored clothes corresponds to linking here. In addition, associating a park included in the augmented reality diorama with a place (virtually represented live stage or the like) in which a live music video is played back corresponds to linking here.

Displaying the augmented reality diorama on the display device means outputting display data for displaying the augmented reality diorama in a superimposed manner on the real space to the apparatus including the display device or to the display device. In addition, displaying the augmented reality diorama on the display device may mean outputting an instruction for displaying the augmented reality diorama in a superimposed manner on the real space to the apparatus including the display device or to the display device.

Displaying the space region on the display device means outputting display data for displaying the space region to the apparatus including the display device or to the display device. Displaying the space region on the display device may mean outputting an instruction for displaying the space region to the apparatus including the display device or to the display device.

As an aspect of the eighth embodiment, the user can perform various transaction actions in a preferred virtual space. In addition, since the virtual store can be dynamically constructed in an associated state with the augmented reality diorama, the virtual space can be flexibly utilized in transaction.

### Ninth Embodiment

A summary of a ninth embodiment of the present disclosure will be described. Hereinafter, a virtual store management program executed in a server will be illustratively described as the ninth embodiment.

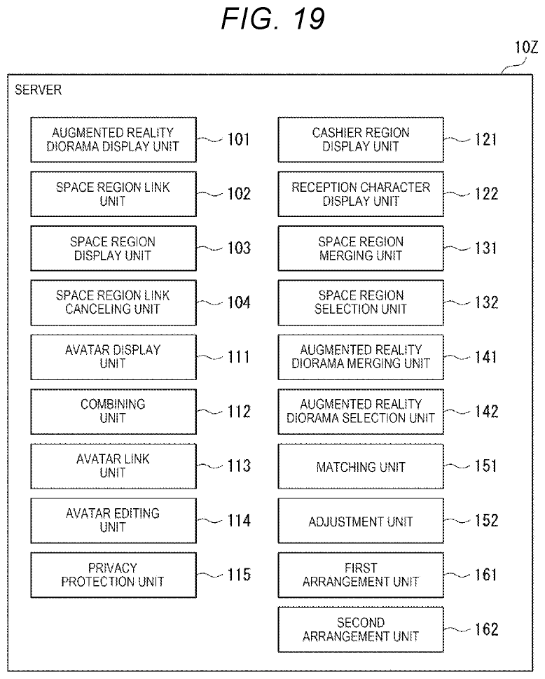

FIG. 19 is a block diagram illustrating a configuration of the server according to at least one embodiment of the present disclosure. A server 10Z that is an example of the configuration of the server 10 includes the augmented reality diorama display unit 101, the space region link unit 102, the space region display unit 103, and a space region link canceling unit 104. The server 10Z further includes the avatar display unit 111, the combining unit 112, an avatar link unit 113, an avatar editing unit 114, and a privacy protection unit 115. The server 10Z further includes the cashier region display unit 121 and a reception character display unit 122. The server 10Z further includes the space region merging unit 131 and a space region selection unit 132. The server 10Z further includes the augmented reality diorama merging unit 141 and an augmented reality diorama selection unit 142. The server 10Z further includes the matching unit 151 and an adjustment unit 152. The server 10Z further includes a first arrangement unit 161 and a second arrangement unit 162.

The processor included in the server 10Z functionally implements the augmented reality diorama display unit 101, the space region link unit 102, the space region display unit 103, the space region link canceling unit 104, the avatar display unit 111, the combining unit 112, the avatar link unit 113, the avatar editing unit 114, the privacy protection unit 115, the cashier region display unit 121, the reception character display unit 122, the space region merging unit 131, the space region selection unit 132, the augmented reality diorama merging unit 141, the augmented reality diorama selection unit 142, the matching unit 151, the adjustment unit 152, the first arrangement unit 161, and the second arrangement unit 162 by referring to the virtual store management program held (installed) in the storage device and executing the program.

The augmented reality diorama display unit 101 has a function of displaying the augmented reality diorama superimposed on the real space on the display device. The space region link unit 102 has a function of linking one or more virtual space regions to the augmented reality diorama. The space region display unit 103 has a function of displaying the space region linked to the augmented reality diorama on the display device. The space region link canceling unit 104 has a function of canceling the link between the augmented reality diorama and one or more space regions.

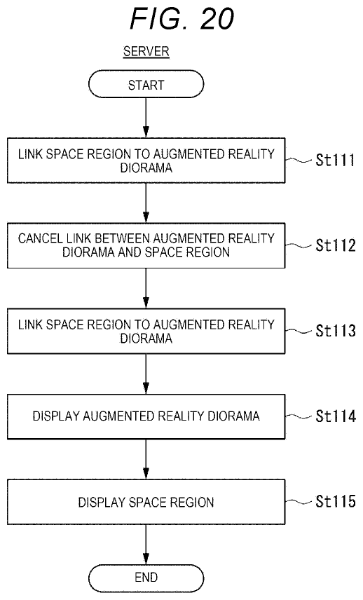

FIG. 20 is a flowchart illustrating an example of a virtual store management process according to at least one embodiment of the present disclosure.

The space region link unit 102 links one or more virtual space regions to the augmented reality diorama (St111). The space region link canceling unit 104 cancels the link between the augmented reality diorama and one or more space regions (St112). The space region link unit 102 links one or more virtual space regions to the augmented reality diorama again (St113). In such a manner, the server 10Z can link the space region to the augmented reality diorama and cancel the link. Accordingly, the space region corresponding to the virtual store can be freely arranged and removed with respect to the augmented reality diorama.

The augmented reality diorama display unit 101 displays the augmented reality diorama superimposed on the real space on the display device (St114). The space region display unit 103 displays the space region linked to the augmented reality diorama on the display device (St115).

The virtual space region is a region corresponding to the virtual store managed by the virtual store management program in the virtual space. For example, the virtual space may be a virtual three-dimensional coordinate space having an X axis, a Y axis, and a Z axis orthogonal to each other. However, the virtual space is not limited to the three-dimensional space and may be a two-dimensional space or the like depending on cases. The space region may be a closed space region such as an indoor store. The space region may be a space region that is not closed, such as an outdoor store or an event venue.

The real space means a space in the real world. The virtual space augmented from the real space means a virtual space (AR space) that can be output in a superimposed manner on the real space.

The virtual store means a virtual place in which products are sold to the user, or any services are provided. For example, a virtual representation of an actual store of a tailor shop using 3D data or a virtual representation, using 3D data, of an actual store of a vocal class in which singing is taught to the user corresponds to the virtual store. Types of products or services dealt at the virtual store are not limited to the above.

The augmented reality diorama means a virtual diorama output in a superimposed manner on the real space. Examples of the augmented reality diorama include a street, a road, a railway, a building, a group of buildings, a stadium of baseball, soccer, or the like, a shrine or a temple, a castle, a mountain, the sea, a river, a swamp, a grove, a forest, a field, a paddy field, an airport, an underground passage, a cave, and the like represented as 3D model data for the augmented reality (AR) display. The augmented reality diorama may not necessarily be based on a modern landscape that exists in the reality. Examples of the augmented reality diorama also include a medieval European streetscape or construction and a fictional streetscape or construction appearing in an animation, a comic book, or the like.

Linking the space region to the augmented reality diorama means associating the augmented reality diorama with the space region. For example, associating a second floor of a building included in the augmented reality diorama with the space region corresponding to the virtual store selling tailored clothes corresponds to linking here. In addition, associating a park included in the augmented reality diorama with a place (virtually represented live stage or the like) in which a live music video is played back corresponds to linking here.

Canceling the link between the augmented reality diorama and the space region means eliminating the association between the augmented reality diorama and the space region.

Displaying the augmented reality diorama on the display device means outputting display data for displaying the augmented reality diorama in a superimposed manner on the real space to an apparatus (for example, the user terminal 20) including the display device or to the display device. In addition, displaying the augmented reality diorama on the display device may mean outputting an instruction for displaying the augmented reality diorama in a superimposed manner on the real space to the apparatus (for example, the user terminal 20 capable of generating or storing the display data) already having the display data or to the display device.

Displaying the space region on the display device means outputting display data for displaying the space region to the apparatus (for example, the user terminal 20) including the display device or to the display device. Displaying the space region on the display device may mean outputting an instruction for displaying the space region to the apparatus (for example, the user terminal 20 capable of generating or storing the display data) already having the display data or to the display device.

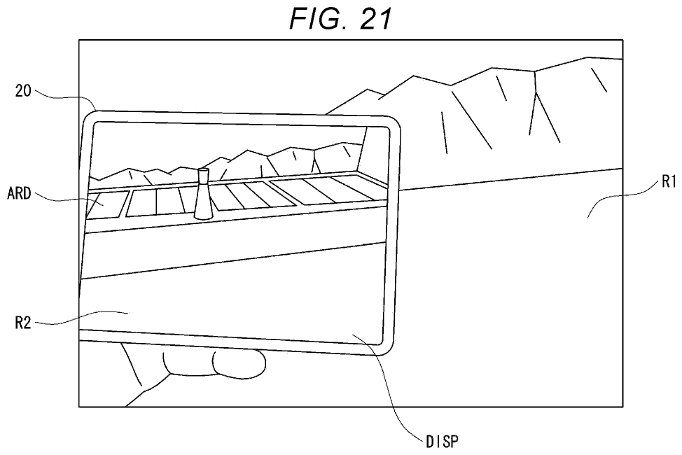

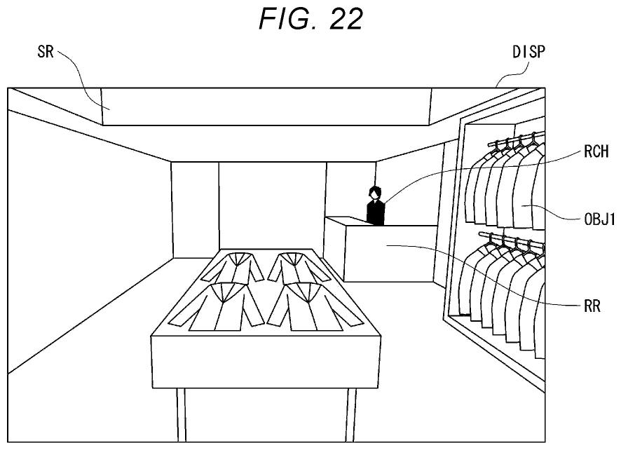

FIG. 21 is a conceptual diagram illustrating a display example of the augmented reality diorama by the display device according to at least one embodiment of the present disclosure. The user directs the user terminal 20 that is a tablet terminal toward a real space R1. The user terminal 20 includes a display device DISP. In the present example, the display device DISP is a touch panel display included in the user terminal 20. A captured image captured by the camera (not illustrated) included in the user terminal 20 is displayed by the display device DISP. An augmented reality diorama ARD is displayed on the display device DISP in a superimposed manner on a real space R2. The real space R1 is the actual real space, and the real space R2 is a real space displayed on the display device DISP. In a case of using the AR glasses or the like, the real space R1 enters a field of view of the user. The augmented reality diorama ARD is displayed in 3D by the display device DISP. Multiple buildings, roads, and the like are arranged in the augmented reality diorama ARD. The user selects a region that is included in the augmented reality diorama ARD and corresponds to a store. In the present example, this selection is performed by tapping a predetermined region of the touch panel display. This selection may be performed by the controller CTR, a gesture input, or the like (refer to FIG. 1 or FIG. 14). In a case where the region corresponding to the store is selected, next, a space region corresponding to the store is displayed on the display device (refer to FIG. 22).

FIG. 22 is a conceptual diagram illustrating a display example of the space region by the display device according to at least one embodiment of the present disclosure. A virtual space region SR corresponding to a store selling tailored clothes is displayed in 3D on the display device DISP. The space region SR corresponds to the store (virtual store) that is virtual. The space region SR may be displayed in a superimposed manner on the real space (AR display) or may be displayed without being superimposed on the real space (VR display). The user can purchase the product in the space region SR that is the virtual store displayed on the display device DISP, and can receive provision of the service. In FIG. 22, a virtual object OBJ1 corresponding to tailored clothes that are the product purchasable by the user is displayed on the display device DISP. A virtual cashier region RR and a reception character RCH will be described later.

Display of Avatar and Combining with Virtual Object

Next, display of the avatar and combining the avatar with the virtual object will be described with reference to FIG. 19 again. The avatar display unit 111 has a function of displaying the virtual avatar associated with the user on the display device together with the augmented reality diorama or the space region. The combining unit 112 has a function of combining the avatar with the virtual object having the predetermined correspondence relationship with the space region. The avatar link unit 113 has a function of associating any one or more of a plurality of the virtual avatars with the user in accordance with input information. The avatar editing unit 114 has a function of changing a parameter or a form of the avatar in accordance with input information. The privacy protection unit 115 has a function of restricting disclosure of one or more parameters of the avatar associated with the user to another user different from the user.

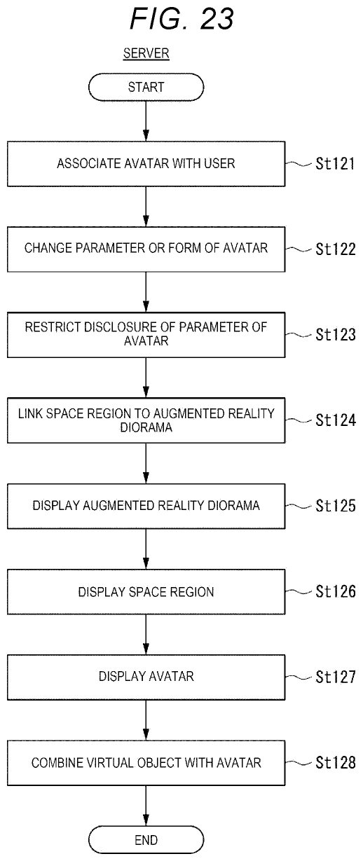

FIG. 23 is a flowchart illustrating an example of a virtual store management process according to at least one embodiment of the present disclosure.

The avatar link unit 113 associates any one or more of the plurality of virtual avatars with the user in accordance with the input information (St121). The avatar editing unit 114 changes the parameter or the form of the avatar in accordance with the input information (St122). The privacy protection unit 115 restricts disclosure of one or more parameters of the avatar associated with the user to another user different from the user (St123). The space region link unit 102 links one or more virtual space regions to the augmented reality diorama (St124). The augmented reality diorama display unit 101 displays the augmented reality diorama superimposed on the real space on the display device (St125). The space region display unit 103 displays the space region linked to the augmented reality diorama on the display device (St126). The avatar display unit 111 displays the virtual avatar associated with the user on the display device together with the augmented reality diorama or the space region (St127). The combining unit 112 combines the avatar with the virtual object having the predetermined correspondence relationship with the space region (St128).

The avatar means a character as an alter ego. The user can express an intention or perform an action by selecting an appearance of the character set by the user (or designated by the program or the like) in the virtual space. The appearance of the avatar may resemble the appearance of the user or may be different from the appearance of the user. The avatar may be an inanimate object such as a chair, a desk, or a weapon. In addition, the avatar here may be an avatar of the user or may be an avatar of an entity (a friend, a family member, another person, a celebrity, a pet, or the like) other than the user. That is, the avatar may be an alter ego of an entity not limited to the user in the real world.

The parameter of the avatar is a value indicating an attribute of the avatar. For example, examples of the parameter include values indicating a body size such as a body length, a weight, a chest circumference, and a sitting height. The form of the avatar means an appearance (a shape, a pattern, or a color, or a combination thereof) of the avatar in a predetermined basic pose.

Displaying the avatar on the display device means outputting display data for displaying the avatar to the apparatus (for example, the user terminal 20) including the display device or to the display device. Displaying the avatar on the display device may mean outputting an instruction for displaying the avatar to the apparatus (for example, the user terminal 20 capable of generating or storing the display data) already having the display data or to the display device.

The virtual object means an object that can be output in the virtual space. Examples of the virtual object include a virtual representation of an article related to provision of the service or the product using 2D model data, 3D model data, or the like. Examples of the product include clothes, shoes, a backpack, a doll, a personal computer, a mobile phone, an automobile, a motorcycle, a ship, and the like. The product is not limited thereto and may be an article available for commercial transaction. The article related to provision of the service means an article related to the service such as a brush for coloring a nail or an artificial nail in a case where the service is for nail art.

Besides, examples of the virtual object include an item that can be output (for example, displayed) in the virtual space. For example, the item may be a sword, a shield, a helmet, an armor, a wand, clothes, an orb, a gun, a musical instrument, or a vehicle. The virtual object may be an animate object such as a bird, a cat, a dog, a dinosaur, grass, or a tree or a fictional animate object such as a dragon, as long as the virtual object is related to commercial transaction. For example, a form of service provision such as virtually showing a play in which a dragon appears at a movie theater that is the virtual store is considered. Besides, a building, a street, a continent or a planet, a star, a character appearing in a video game, and the like that are virtually represented may correspond to the virtual object here as long as the virtual representation is related to commercial transaction. The space region and the augmented reality diorama are also considered to be usable as a target of commercial transaction as data and thus, may correspond to the virtual object. These virtual objects may be held in the storage device included in the virtual store management system 100 or the storage device connectable to the virtual store management system 100 in the format of 2D model data, 3D model data, or the like.

For example, the predetermined correspondence relationship between the space region and the virtual object is a relationship such that the object is a virtual representation of the article related to provision of the service or the product of the store with respect to the space region that is the store.

Combining the virtual object with the avatar means using the object and the avatar together. For example, in a case where the object is virtual clothes, causing the avatar to wear (try on) the clothes corresponds to combining here. In a case where the object is a virtual automobile, causing the avatar to get in the automobile and drive (test-drive) based on a user operation corresponds to combining here. Besides, combining the virtual object with the avatar may have various aspects corresponding to types of objects.

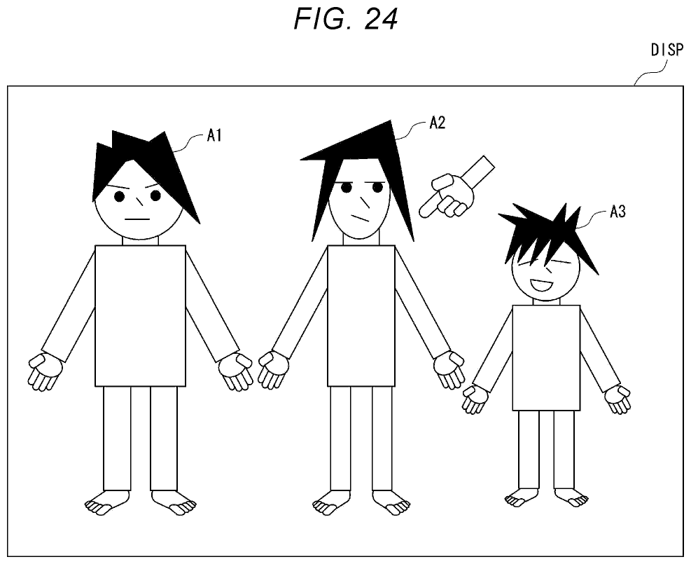

FIG. 24 is a conceptual diagram illustrating association of the avatar with the user according to at least one embodiment of the present disclosure. Three avatars A1, A2, and A3 selectable by the user are displayed on the display device DISP of the user terminal 20. The user selects one or more avatars by, for example, tapping the touch panel display. In the example in FIG. 24, the user selects the avatar A2. Information indicating this avatar selection is transmitted to the server 10Z from the user terminal 20 through the communication network 30 as input information. The avatar link unit 113 associates the avatar A2 that is one of the plurality of avatars A1, A2, and A3 with the user in accordance with the input information (step St121).

Data (2D data, 3D modeling data, or the like) of the avatars selectable by the user may be stored in advance in a storage device accessible from the server 10Z, the user terminal 20, or the like. Besides, for example, means for measuring the body size of the user may measure the body size of the user, and any computer may newly generate the data of the avatars based on a measured value. For example, the means for measuring the body size is a box type scanning apparatus in which the user can enter. Besides, a body of the user may be imaged from various angles using the camera included in the user terminal 20 that is a smartphone, and the user terminal 20, the server 10, the other server 40, or the like may estimate the body size based on a captured image. In addition, the body size may be acquired by other means.

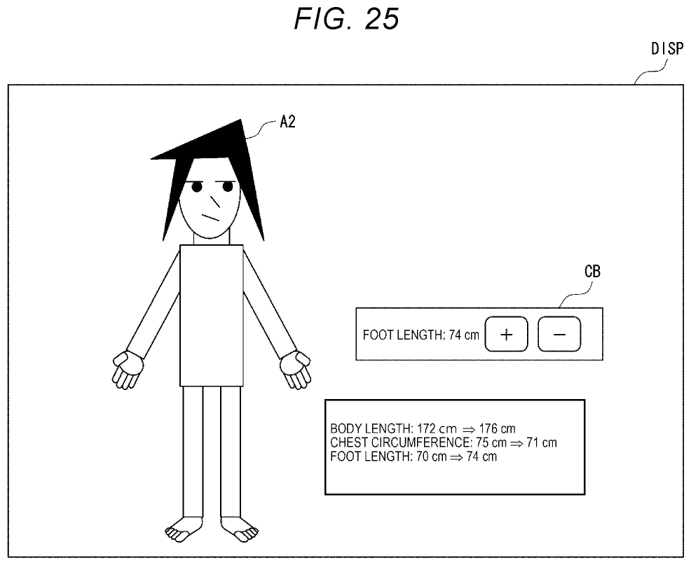

FIG. 25 is a conceptual diagram illustrating changing of the parameter or the form of the avatar according to at least one embodiment of the present disclosure. The avatar A2 associated with the user by selection is displayed on the display device DISP of the user terminal 20. The user changes a foot length of the avatar A2 by tapping a button in a control box CB displayed for increasing or decreasing the foot length that is the parameter of the avatar A2. In the example in FIG. 25, the user increases the foot length of the avatar A2 by 4 cm by tapping a + button four times. Consequently, the foot length of the avatar A2 is increased from 70 cm to 74 cm. Accordingly, the body length is increased from 172 cm to 176 cm. The avatar editing unit 114 controls changing of the parameter or the form of the avatar A2 based on input information from the user. In the present example, information indicating that the + button is tapped is transmitted to the server 10Z from the user terminal 20 as the input information. The user terminal 20 may include the avatar editing unit 114, and the user terminal 20 may transmit 3D model data of the avatar of which editing is completed to the server 10Z.

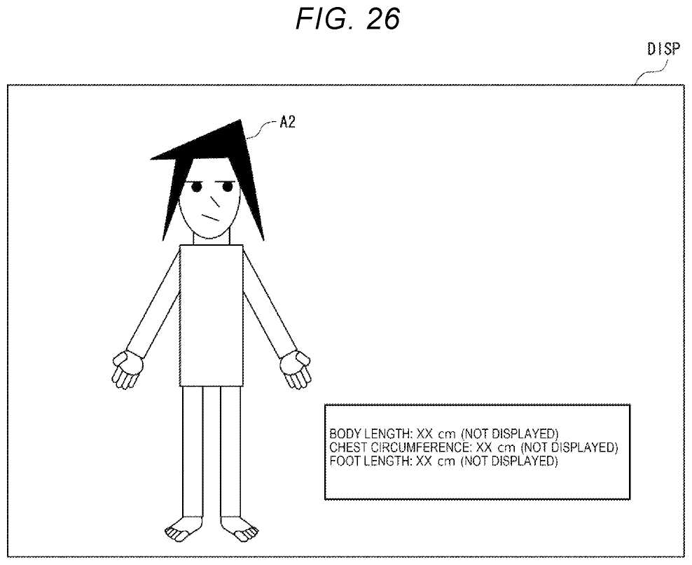

FIG. 26 is a conceptual diagram illustrating a look of the avatar in a view from another user according to at least one embodiment of the present disclosure. The user associated with the avatar A2 is a first user, and the other user is a second user. Even in a case where the avatar A2 associated with the first user is displayed on the display device DISP of the user terminal used by the second user, a numerical value of the parameter such as the body length, a chest circumference, or the foot length is not displayed. The parameter such as the body length, the chest circumference, or the foot length of the avatar A2 may be set based on a size of an actual body of the first user. That is, since these parameters are personal information of the first user, the privacy protection unit 115 restricts disclosure of the parameters to the second user from a viewpoint of privacy protection. Which parameter of a plurality of parameters is not allowed to be disclosed to the other user can be appropriately decided in accordance with a content indicated by the parameter.

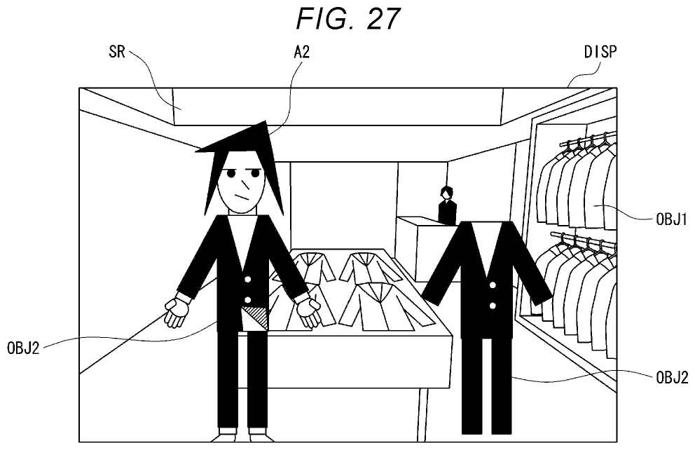

FIG. 27 is a conceptual diagram illustrating an example of combining the virtual object with the avatar according to at least one embodiment of the present disclosure. In the present example, a virtual object OBJ2 is tailored clothes arranged in the space region SR as a product, and combining the virtual object OBJ2 with the avatar A2 corresponds to trying on the virtual object OBJ2. The avatar display unit 111 displays the virtual avatar A2 associated with the user on the display device DISP together with the space region SR corresponding to the virtual store (step St127). The avatar A2 may be displayed in a superimposed manner on the real space (AR display).

Products are arranged in the space region SR corresponding to the virtual store. The virtual objects OBJ1 and OBJ2 having a shape of clothes correspond to the products of the virtual store. The user (first user; hereinafter, the same applies) selects the virtual object OBJ2 as a target to be combined with the avatar A2 by, for example, tapping a product to be tried on among the products arranged in the space region SR. Then, the combining unit 112 combines the avatar A2 with the virtual object OBJ2 having the predetermined correspondence relationship with the space region SR (step St128). The predetermined correspondence relationship in the present example is a relationship in which the space region SR is a virtual store selling tailored clothes, and the virtual object OBJ2 is a product of the virtual store. However, the relationship between the space region and the virtual object is not limited to the above relationship. As a result of combining, the avatar A2 tries on virtual tailored clothes. As described above, the body size of the avatar A2 may be based on the size of the actual body of the user or may be based on a size of a body of another person having a predetermined relationship with the user.

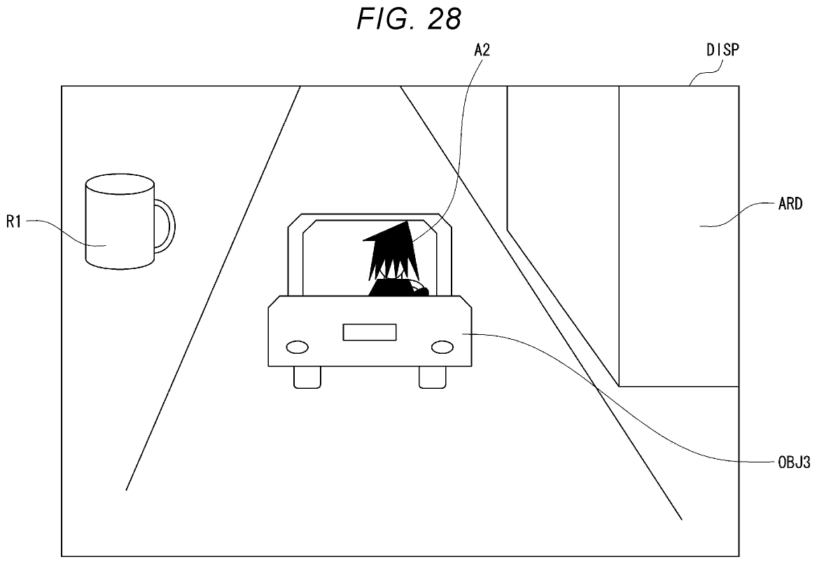

FIG. 28 is a conceptual diagram illustrating an example of combining the virtual object with the avatar according to at least one embodiment of the present disclosure. In the present example, a virtual object OBJ3 is a virtual automobile obtained by modeling an automobile in the real space in 3D. The space region SR (not illustrated) is a virtual showroom operated by an automobile dealership. Combining the avatar A2 with the object OBJ3 corresponds to test-driving the virtual automobile. The avatar display unit 111 displays the virtual avatar A2 associated with the user on the display device DISP together with the augmented reality diorama ARD (step St127).

A building that is a part of the augmented reality diorama ARD is displayed on the display device DISP of the user terminal 20 in a superimposed manner on the real space R1. A cup present in the real space R1 is captured on the display device DISP. The virtual object OBJ3 and the avatar A2 are combined and displayed on the display device DISP. The avatar A2 gets in the object OBJ3 that is the virtual automobile and drives the object OBJ3. That is, the user can test-drive the virtual automobile through the avatar A2.

As the operation input, the user can perform a tap on the touch panel display included in the user terminal 20, a gesture operation such as inclining the user terminal 20 or shaking the user terminal 20 left to right, or the like. The operation input of the user may be a button input into the controller CTR (refer to FIG. 1 or FIG. 14), a gesture input such as shaking a hand in front of the camera included in the user terminal 20, or the like. The server 10Z may control movement of the object OBJ3, which is the virtual automobile, in the augmented reality diorama ARD or the space region SR based on these operation inputs. Controlling movement of the object OBJ3 by the server 10Z may be performed in a state where the same operation characteristics (acceleration performance, cornering performance, vibration absorption performance, and the like) as an automobile in the real world are simulated. By doing so, the user can try quality of the product present in the real space through the avatar in the virtual space.

The object as a target to be combined with the avatar may be a virtual representation of the article related to provision of the service. Accordingly, the user can try quality of the service received in the real space through the avatar in the virtual space.

Display of Cashier Region

Next, display of the cashier region will be described with reference to FIG. 19 again. The cashier region display unit 121 has a function of displaying the virtual cashier region for causing the user to acquire the predetermined permission for the virtual object having the predetermined correspondence relationship with the space region or an object in the real space corresponding to the object, on the display device in association with the space region. The reception character display unit 122 has a function of displaying one or more reception characters that serve the user on the display device together with the cashier region.

The cashier region display unit 121 may display a transaction screen for transaction on the display device.

The reception character display unit 122 may display a reception character having a parameter or a form corresponding to an actual article usable in the real space by the user on the display device together with the cashier region.

The reception character may be automatically controlled or may be controllable by a person other than the user.

The reception character display unit 122 may display a plurality of reception characters that serve the user on the display device together with the cashier region. The automatically controlled reception character and the reception character controllable by a person other than the user may coexist among the plurality of reception characters. Furthermore, the user may be able to select one or more reception characters that serve the user from the plurality of reception characters displayed together with the cashier region.

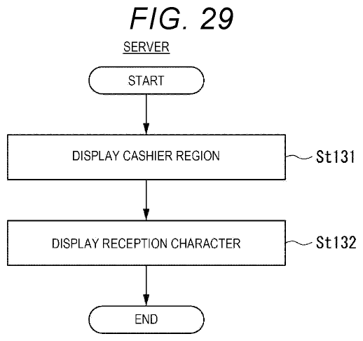

FIG. 29 is a flowchart illustrating an example of a virtual store management process according to at least one embodiment of the present disclosure.

The cashier region display unit 121 displays the virtual cashier region for causing the user to acquire the predetermined permission for the virtual object having the predetermined correspondence relationship with the space region or the object in the real space corresponding to the object, on the display device in association with the space region (St131). The reception character display unit 122 displays one or more reception characters that serve the user on the display device together with the cashier region (St132). It is also possible not to provide step St132. That is, only the virtual cashier region may be displayed without displaying the reception character, and a transition may be made to the transaction screen by selecting the cashier region by tapping or the like. In addition, the cashier region and the transaction screen may be integrated or may be separately displayed.

The predetermined permission means various permissions that can be acquired by the user for an object in the real space or the virtual space. For example, for the object in the real space, a permission to possess the object by purchase, a permission to use the object by receiving a license of use, a permission to be capable of temporarily managing the object by renting, and a permission to transfer or lease the object by obtaining a license of transfer or lease to another person correspond to the permission here. For example, the object in the virtual space, a permission to use the object for a certain period or indefinitely by paying, a permission to copy the object by obtaining a license of copying, and a permission to transfer or lease the object to another user by obtaining a license of transfer or lease to another person correspond to the permission here. A permission to, for example, modify, enlarge, reduce, unify, develop, degenerate the object by obtaining a license may also correspond to the permission here.

The virtual cashier region means a region displayed in the virtual space in order to cause the user to acquire the permission. For example, a virtual representation of a cashier counter in a real store using 2D or 3D modeling data or the like is an example of the cashier region. The cashier region may be a region in which the user pays a price (money, points, or the like) for acquiring the permission in the cashier region, or may be a region in which the price is not paid as in a case of, for example, free transfer.

Displaying the virtual cashier region on the display device means outputting display data for displaying the virtual cashier region to the apparatus (for example, the user terminal 20) including the display device or to the display device. Displaying the virtual cashier region on the display device may mean outputting an instruction for displaying the virtual cashier region to the apparatus (for example, the user terminal 20 capable of generating or storing the display data) already having the display data or to the display device. For example, displaying the virtual cashier region on the display device in association with the space region means displaying the virtual cashier region at a position having a predetermined relationship with the space region, such as in or near the space region corresponding to the virtual store.

Transaction means an action in which the user receives any benefit, such as purchasing the product, receiving the transfer, or receiving the service.

For example, the reception character means a character that serves the user by interacting with the user, such as the store clerk of the store. Displaying the reception character on the display device means outputting display data for displaying the reception character to the apparatus (for example, the user terminal 20) including the display device or to the display device. Displaying the reception character on the display device may mean outputting an instruction for displaying the reception character to the apparatus (for example, the user terminal 20 capable of generating or storing the display data) already having the display data or to the display device. For example, displaying the reception character on the display device together with the cashier region means displaying the reception character at a position having a predetermined relationship with the cashier region, such as in or near the cashier region.

For example, the reception character having the parameter or the form corresponding to the actual article usable in the real space by the user means the reception character or the like having a parameter or a form corresponding to a figure in a case where the user purchases the figure present in the real space. The actual article usable in the real space by the user is not limited to a human-shaped article.

Here, FIG. 22 will be referred to again. The space region SR is displayed on the display device DISP included in the user terminal 20. The cashier region display unit 121 displays the virtual cashier region RR on the display device DISP in association with the space region SR. The reception character display unit 122 displays the reception character RCH on the display device DISP together with the cashier region RR. By arranging the cashier region and the reception character in association with the space region SR, the user who uses the virtual store can clearly understand where and what to do in order to perform transaction such as settlement and can perform transaction at the virtual store.

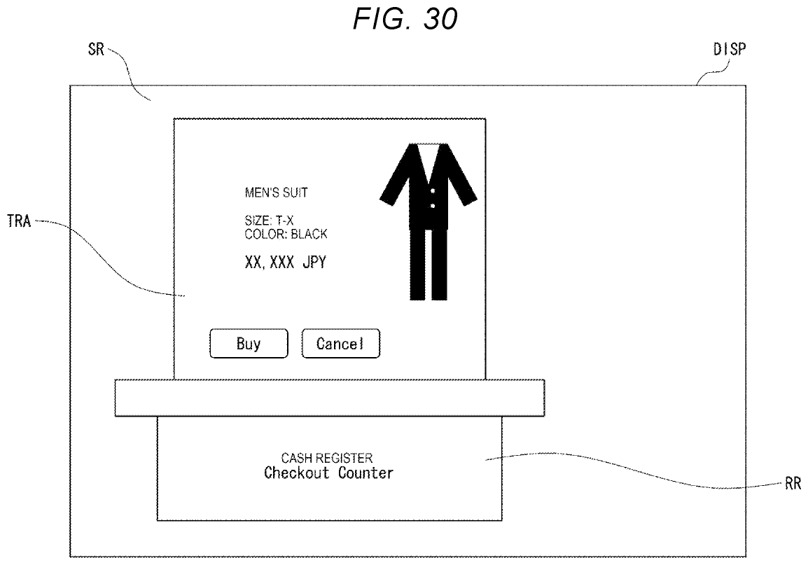

FIG. 30 is a conceptual diagram illustrating a display example of the transaction screen according to at least one embodiment of the present disclosure. The space region SR is displayed on the display device DISP included in the user terminal 20. Walls of the space region SR, the arranged products, and the like are not illustrated. The cashier region display unit 121 displays a transaction screen TRA for transaction on the display device DISP. A layout and a user interface of the transaction screen TRA are not particularly limited. In the present example, a thumbnail image of tailored clothes that are a product of a purchase target, and a size, a color, an amount of money for purchase, and the like of the tailored clothes are displayed on the transaction screen TRA. In addition, a Buy button and a Cancel button are displayed on the transaction screen TRA in the present example. The user can purchase the tailored clothes by tapping the Buy button. In a case where the user taps the Cancel button, for example, the transaction screen TRA is not displayed.

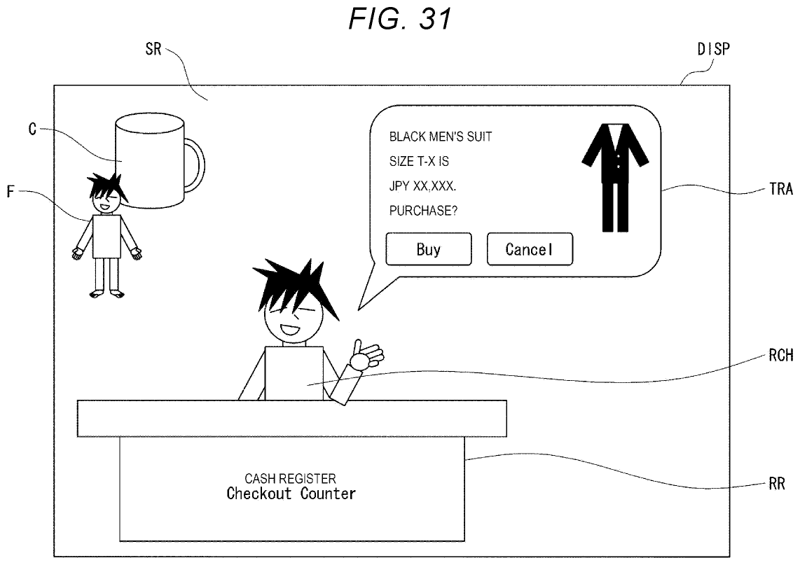

FIG. 31 is a conceptual diagram illustrating a display example of the reception character having the parameter or the form corresponding to the actual article according to at least one embodiment of the present disclosure. The space region SR is displayed in AR on the display device DISP included in the user terminal 20. Walls of the space region SR, the arranged products, and the like are not illustrated. The cashier region RR and the reception character RCH are displayed on the display device DISP. In the present example, the transaction screen TRA is displayed as a form of a speech balloon showing a content of speech of the reception character RCH. However, the reception character RCH may speak by outputting a voice. The reception character RCH may communicate with the user by a gesture or the like. In addition, the user terminal 20 may acquire user information indicating a speech or an expression of the user by a microphone included in the user terminal 20, a camera directed to the user side, or the like. Then, the reception character RCH may communicate with the user based on the user information.

Here, a cup C and a figure F present in the real space are captured on the display device DISP. The reception character RCH has a form corresponding to the figure F that is an actual article. In such a manner, the reception character RCH can be changed to have a preferred parameter or form in accordance with the figure F or the like held by the user. The reception character display unit 122 may display the reception character RCH of which the parameter such as voice quality is changed in accordance with the actual article, on the display device DISP. That is, the user can freely select the reception character RCH that serve the user through the article present in the real space.

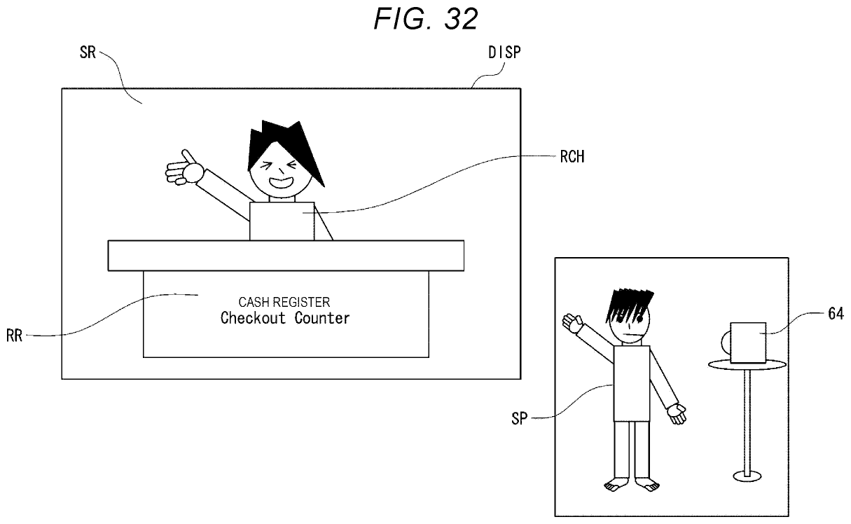

FIG. 32 is a conceptual diagram illustrating a control example of the reception character according to at least one embodiment of the present disclosure. The space region SR is displayed in AR on the display device DISP included in the user terminal 20. Walls of the space region SR, the arranged products, and the like are not illustrated. The cashier region RR and the reception character RCH are displayed on the display device DISP.

In the present example, an operation of the reception character RCH is in connection with an operation of the receptionist SP. The receptionist SP is a person other than the user holding the user terminal 20. The camera 64 included in the receptionist apparatus 60 images the shape of the receptionist SP, and the operation of the reception character RCH is controlled based on a captured image (refer to FIG. 1 and FIG. 14). An entity that controls the operation of the reception character RCH may be the server 10Z or the user terminal 20.

The reception character RCH may have the same form as the receptionist SP. That is, the captured image obtained by imaging the receptionist SP may be displayed on the display device DISP as the reception character RCH. The reception character RCH may be an avatar of the receptionist SP having a different appearance from the receptionist SP.

In addition, while illustration is not provided, the operation, speech, and the like of the reception character RCH may be automatically controlled by using a program or the like for controlling a character. The program for controlling the character may be implemented using artificial intelligence (for example, character A1).

In a case where the reception character RCH is automatically controlled, an operator of the virtual store can reduce human resources for serving the user.

In a case where the reception character RCH is controlled by a person, the user can perform transaction using the virtual store in a natural state like meeting an actual store clerk in the real world. In addition, the store clerk can sell products and provide a service to the user living in a remote location through the virtual store. Furthermore, it is possible to contribute to creation of new employment opportunities such as a person controlling the reception character at the virtual store. In addition, in a case where the reception character RCH is the avatar of the receptionist SP having a different appearance from the receptionist SP, a desire to change by the receptionist SP can be satisfied.

Merging Between Space Regions

Next, merging between the space regions will be described with reference to FIG. 19 again. The space region merging unit 131 has a function of merging two or more space regions. The space region selection unit 132 has a function of selecting two or more space regions of merging targets by a space region merging function based on at least one of input information provided by the user and predetermined accumulated information.

The space region merging unit 131 may change at least one space region of the merging target in accordance with at least the other space region of the merging target and then, merge both space regions.

The space region merging unit 131 may provide a connection region between at least one space region of the merging target and at least the other space region of the merging target and then, merge both space regions.

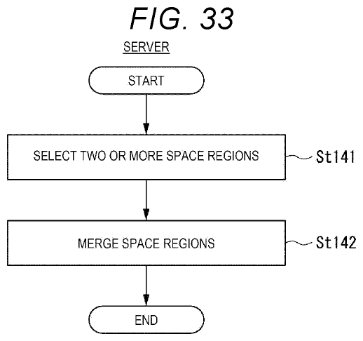

FIG. 33 is a flowchart illustrating an example of a virtual store management process according to at least one embodiment of the present disclosure.

The space region selection unit 132 selects two or more space regions of the merging targets by the space region merging function based on at least one of the input information provided by the user and the predetermined accumulated information (St141). The space region merging unit 131 merges two or more space regions (St142).

For example, merging two or more space regions means integrating a plurality of space regions as in a case of connecting a space region corresponding to a virtual store selling tailored clothes to a space region corresponding to a virtual store selling shoes.

Changing the space region refers to performing a process that generates any difference in the space region in a case of comparing the space region before and after the change. For example, enlarging, reducing, or modifying the space region or removing a part of the space region corresponds to changing of the space region. In addition, a process that generates any change inside the space, such as changing the parameter or the form of the object included in the space region, removing the object included in the space region, or newly adding an object to the space region, corresponds to changing of the space region.

The connection region means a region that is interposed in a case of connecting a certain space region to another space region so that both space regions can be smoothly connected. For example, a region of a passageway type that connects two spaces to each other corresponds to the connection region. In addition, a region obtained by representing a gate or a window for moving from one space region to another space region, a drawer of a desk, or the like as 3D data corresponds to the connection region. Besides, for example, in a case of connecting a cuboid space region to a triangular pyramidal space region, a space region having a shape that fills between the cuboid space region and the triangular pyramidal space region corresponds to the connection region.

The input information provided by the user means input information caused by the user. For example, information input through the user terminal 20 corresponds to the input information provided by the user. The server 10Z may acquire the input information from the user terminal 20 through the communication network 30.

In addition, input information that is separately acquired by the server 10Z without the user terminal 20 may be used as the input information provided by the user. For example, in a case where action history information about an action that is performed in the past in the augmented reality diorama or the space region by the avatar associated with the user is acquired by the server 10Z as log data, the log data may correspond to the input information provided by the user. In addition, information that is related to the user and is acquired from an external system such as the other server 40 by the server 10Z corresponds to the input information provided by the user. For example, the input information provided by the user here may include purchase history information in a case where the user purchases a product using another product sales site, use history information in a case where the user uses transportation such as an electric train, contents data posted by the user using an SNS service, and text information indicating a speech made through the SNS service.

The accumulated information means information accumulated in a storage device accessible from a process entity (here, the server 10Z). For example, information that indicates the number of sold products of a certain store on a certain day and is stored in the storage device, and information that indicates the number of customers visiting the store in a predetermined time range and is stored in the storage device correspond to the accumulated information. Financial information of the store that is stored in the storage device, such as numerical values disclosed in a balance sheet or a profit and loss statement, also corresponds to the accumulated information. The accumulated information is not limited to statistical information. For example, in a case where data indicating a review or a comment of an expert on the SNS is stored in the storage device, the data may also correspond to the accumulated information. That is, the accumulated information includes various information not limited to information related to the individual user. The accumulated information may include various attribute information of the space region and various attribute information of the augmented reality diorama.

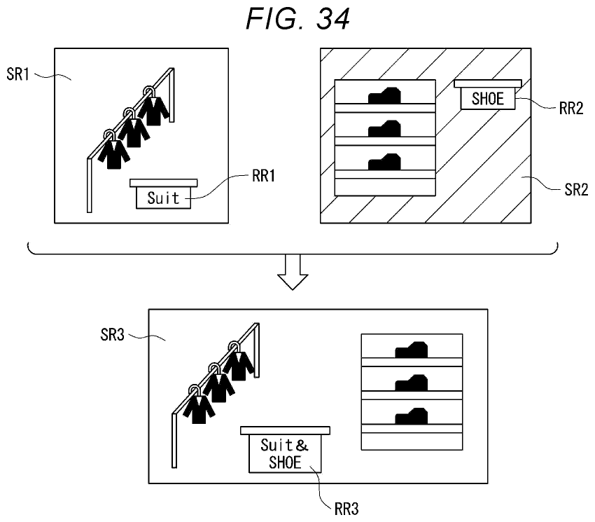

FIG. 34 is a conceptual diagram illustrating a merging example of the space region according to at least one embodiment of the present disclosure. The user inputs information indicating a desire to collectively purchase articles necessary for job hunting into the user terminal 20. The space region selection unit 132 of the server 10Z that acquires the input information through the communication network 30 selects two space regions SR1 and SR2 of the merging targets based on the input information provided by the user. The space region SR1 corresponds to a virtual store selling clothes. The space region SR2 corresponds to a virtual store selling shoes. In a case where these plurality of virtual stores can be merged into one, the user can collectively purchase clothes and shoes necessary for job hunting. In the present example, the space region selection unit 132 infers a purchase target product of the clothes and the shoes from a keyword “job hunting”. A correspondence table or the like between the keyword and the purchase target product may be stored in advance in the storage device. The space region selection unit 132 extracts the virtual store selling clothes and the virtual store selling shoes based on the correspondence table. However, the above is merely an example. An algorithm for selecting a space region using a method other than the correspondence table may be implemented in the server 10Z.

Here, the space region SR1 that is the virtual store selling clothes includes a virtual cashier region RR1 for clothes and has an interior based on white color. Meanwhile, the space region SR2 that is the virtual store selling shoes includes a virtual cashier region RR2 for shoes and has an interior based on brown color. In FIG. 34, the interior based on brown color is represented by diagonal lines.

While this is merely an example, the space region merging unit 131 changes the space region SR2 of the merging target in accordance with the other space region SR1 of the merging target and then, merges both space regions from a viewpoint of staging unity of the interior for the virtual store after merging. Specifically, in order to avoid duplication of the cashier region due to merging with the space region SR1, the space region merging unit 131 removes the cashier region RR2 included in the space region SR2. In addition, the space region merging unit 131 changes the interior of the space region SR2 to an interior based on white color in order to match the interior of the space region SR1.

The space region merging unit 131 merges the space region SR1 with the space region SR2. A space region SR3 after merging includes one virtual cashier region RR3 for clothes and shoes. In addition, the space region SR3 after merging has an interior based on white color. The space region SR3 after merging is displayed on the display device included in the user terminal 20.

As in the above example, a plurality of space regions appropriate for the user are selected, appropriately changed, and then, merged based on various information acquirable by the server 10Z. Accordingly, a virtual store that deals with various products and services matching the needs of the user can be dynamically constructed and provided to the user.

The user, a manager of the server 10Z, the operator of the virtual store, a constructor of the augmented reality diorama, or the like may directly select the plurality of space regions of the merging targets without using the space region selection unit 132. A person may specify only one space region, and the space region selection unit 132 may select (recommend) the other space region.

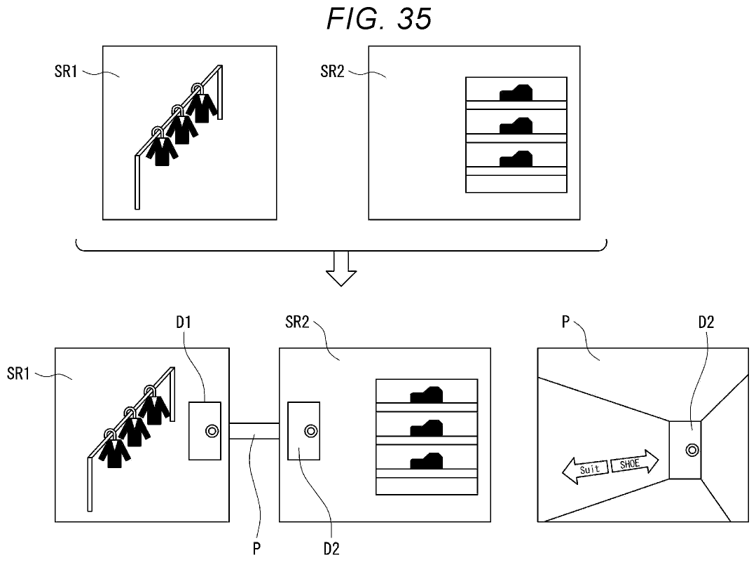

FIG. 35 is a conceptual diagram illustrating a merging example of the space region in a case of using the connection region according to at least one embodiment of the present disclosure. The same elements as in FIG. 34 will not be described. The space region merging unit 131 merges the space region SR1 with the space region SR2. At this point, the space region merging unit 131 provides the connection region between the space region SR1 and the space region SR2 and then, merges both of the space regions SR1 and SR2. In the present example, a door D1, a door D2, and a passage P are provided as the connection region. The passage P is the connection region added by the space region merging unit 131 in order for the user to virtually move between the space region SR1 and the space region SR2. Each of the door D1 and the door D2 opens when the user virtually passes through the passage P. The connection region is not limited to the above example.

In such a manner, by providing the connection region, a plurality of space regions can be smoothly connected, and, for example, the user can enjoy purchasing the product by virtually walking around a plurality of virtual stores.

Merging between Augmented Reality Dioramas

Next, merging between the augmented reality dioramas will be described with reference to FIG. 19 again. The augmented reality diorama merging unit 141 has a function of merging two or more augmented reality dioramas. The augmented reality diorama selection unit 142 has a function of selecting two or more augmented reality dioramas of merging targets by an augmented reality diorama merging function based on at least one of the input information provided by the user and the predetermined accumulated information.

The augmented reality diorama merging unit 141 may change at least one augmented reality diorama of the merging target in accordance with at least the other augmented reality diorama of the merging target and then, merge both augmented reality dioramas.

The augmented reality diorama merging unit 141 may provide the connection region between at least one augmented reality diorama of the merging target and at least the other augmented reality diorama of the merging target and then, merge both augmented reality dioramas.

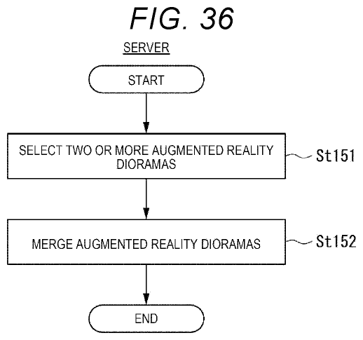

FIG. 36 is a flowchart illustrating an example of a virtual store management process according to at least one embodiment of the present disclosure.

The augmented reality diorama selection unit 142 selects two or more augmented reality dioramas of the merging targets by the augmented reality diorama merging function based on at least one of the input information provided by the user and the predetermined accumulated information (St151). The augmented reality diorama merging unit 141 merges two or more augmented reality dioramas (St152).

For example, merging two or more augmented reality dioramas means integrating a plurality of augmented reality dioramas as in a case of connecting an augmented reality diorama reproducing a streetscape of Akihabara to an augmented reality diorama reproducing a streetscape of Ikebukuro. The plurality of augmented reality dioramas as a merging target may not be adjacent to each other in the real world. In addition, the augmented reality diorama merging unit 141 may merge an augmented reality diorama resembling the real world with an augmented reality diorama resembling the virtual world (for example, a fictional street appearing in a comic book). The augmented reality diorama merging unit 141 may merge a plurality of augmented reality dioramas resembling the virtual world.

Changing the augmented reality diorama refers to performing a process that generates any difference in the augmented reality diorama in a case of comparing the augmented reality diorama before and after the change. For example, enlarging, reducing, or modifying the augmented reality diorama, or removing a part of the augmented reality diorama corresponds to changing of the augmented reality diorama. A process of canceling the link of the space region linked to the augmented reality diorama or newly linking another space region to the augmented reality diorama also corresponds to changing of the augmented reality diorama. In addition, a process that generates any change inside the augmented reality diorama, such as changing the parameter or the form of the object included in the augmented reality diorama, removing the object included in the augmented reality diorama, or newly adding an object to the augmented reality diorama, also corresponds to changing of the augmented reality diorama.

The connection region means a region that is interposed in a case of connecting a certain space region to another space region so that both space regions can be smoothly connected. For example, a forest region or a wall region that is arranged to be interposed between two augmented reality dioramas and is represented as 3D data corresponds to the connection region. In addition, a region obtained by representing a gate, a door, or the like for moving from one augmented reality diorama to another augmented reality diorama as 3D data corresponds to the connection region. Besides, in connecting an augmented reality diorama that has an oblong shape in a case of being projected to a plane along a virtual gravity direction, to an augmented reality diorama having a circular shape, a space region having a shape that fills between the augmented reality dioramas corresponds to the connection region.

The input information provided by the user and the accumulated information are the same as described above and thus, will not be described.

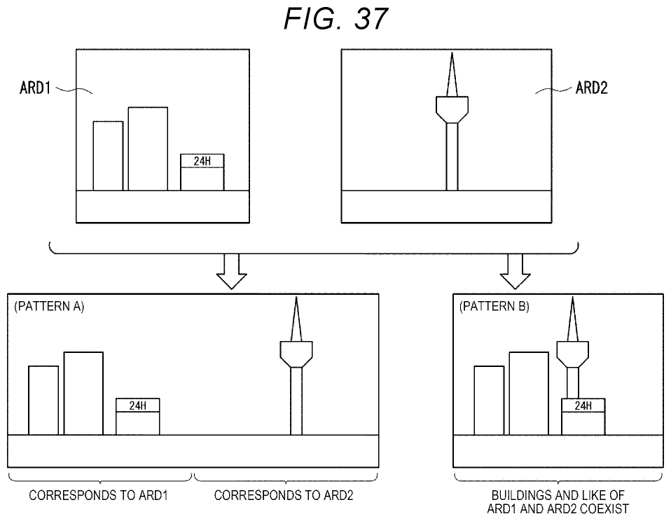

FIG. 37 is a conceptual diagram illustrating a merging example of the augmented reality diorama according to at least one embodiment of the present disclosure. The user inputs information indicating a desire to construct an augmented reality diorama obtained by unifying a local area 1 and a local area 2 into the user terminal 20. In reality, the local area 1 and the local area 2 are present at positions separated from each other. The augmented reality diorama selection unit 142 of the server 10Z that acquires the input information through the communication network 30 selects augmented reality dioramas ARD1 and ARD2 of the merging targets based on the input information provided by the user, the accumulated information indicating an address of the local area 1 that is a workplace of the user, and the accumulated information indicating presence of a large number of tourists near a radio tower built in the local area 2. The augmented reality diorama ARD1 is an augmented reality diorama that reproduces the local area 1. The augmented reality diorama ARD2 is an augmented reality diorama that reproduces the local area 2.

The augmented reality diorama merging unit 141 merges the augmented reality dioramas ARD1 and ARD2. FIG. 37 illustrates two patterns A and B for a method of merging the augmented reality diorama. In a case of the pattern A, merging is performed by connecting a three-dimensional space corresponding to the augmented reality diorama ARD1 to a three-dimensional space corresponding to the augmented reality diorama ARD2. Meanwhile, in a case of the pattern B, merging is performed by adding a part of a construction such as a building or a radio tower included in the augmented reality diorama ARD2 to the three-dimensional space corresponding to the augmented reality diorama ARD1. At this point, the part of the construction included in the augmented reality diorama ARD2 may be added after removing a part of a construction or the like present in the augmented reality diorama ARD1. For example, in such a manner, the augmented reality diorama ARD1 of the merging target may be changed in accordance with the other augmented reality diorama ARD2 of the merging target, and then, the augmented reality dioramas ARD1 and ARD2 may be merged. In addition, the two merging patterns are merely an example. The augmented reality dioramas may be merged using other merging patterns.

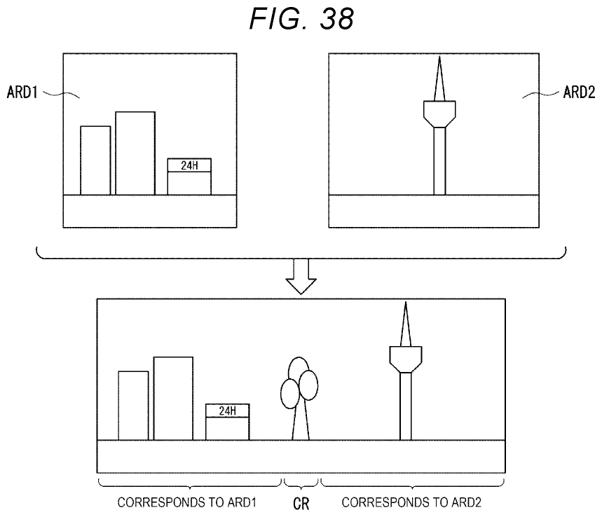

FIG. 38 is a conceptual diagram illustrating a merging example of the augmented reality diorama according to at least one embodiment of the present disclosure. The augmented reality diorama merging unit 141 merges the augmented reality dioramas ARD1 and ARD2 using the method of the pattern A. The augmented reality diorama merging unit 141 provides a connection region CR between the augmented reality dioramas ARD1 and ARD2 and then, merges the augmented reality dioramas ARD1 and ARD2. In the present example, the connection region CR represents a magical forest that connects the local area 1 to the local area 2. For example, the connection region CR may be a region representing a mysterious mountain or a river that connects different areas in an augmented reality diorama resembling a theme park and accompanies a time slip phenomenon.

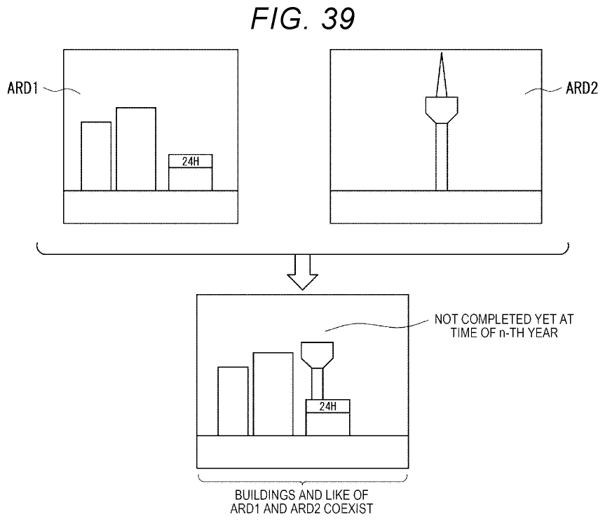

FIG. 39 is a conceptual diagram illustrating a merging example of the augmented reality diorama according to at least one embodiment of the present disclosure. The augmented reality diorama merging unit 141 merges the augmented reality dioramas ARD1 and ARD2 using the method of the pattern B. The augmented reality diorama ARD1 reproduces the local area 1 in an n-th year, and the augmented reality diorama ARD2 reproduces the local area 2 in an (n+2)-th year. Here, n is a natural number. In the n-th year, the radio tower is not completed. Therefore, the augmented reality diorama merging unit 141 changes the augmented reality diorama ARD2 of the merging target to reproduce the time of the n-th year and then, merges the augmented reality diorama ARD2 with the augmented reality diorama ARD1. For example, this can be implemented by storing an augmented reality diorama reproducing the same target in the storage device accessible from the server 10Z for a plurality of ages.

As in the above example, a plurality of augmented reality dioramas appropriate for the user are selected, appropriately changed, and then, merged based on various information acquirable by the server 10Z. Accordingly, an augmented reality diorama matching the needs of the user can be dynamically constructed and provided to the user.

The user, the manager of the server 10Z, the operator of the virtual store, the constructor of the augmented reality diorama, or the like may directly select the plurality of augmented reality dioramas of the merging targets without using the augmented reality diorama selection unit 142. A person may specify only one augmented reality diorama, and the augmented reality diorama selection unit 142 may select (recommend) the other augmented reality diorama.

As in the above example, by merging the augmented reality dioramas, a new augmented reality diorama can be constructed. In addition, in a case where creators of the augmented reality dioramas of the merging targets are different, a new augmented reality diorama can be constructed by collaboration. In addition, it is possible to enjoy combining various augmented reality dioramas. Furthermore, even in a case where zones, ages, styles, or the like of the plurality of augmented reality dioramas of the merging targets are different, the augmented reality dioramas can be smoothly merged by, for example, changing at least one augmented reality diorama or providing a merging region.

Matching between Augmented Reality Diorama and Space Region

Next, matching between the augmented reality diorama and the space region will be described with reference to FIG. 19 again. The matching unit 151 has a function of matching the augmented reality diorama with the space region. The adjustment unit 152 has a function of changing at least one out of at least one augmented reality diorama of a display target and at least one space region in accordance with the other.

The matching unit 151 may perform matching by extracting one or more augmented reality dioramas based on an attribute value of the augmented reality diorama. The matching unit 151 may perform matching by extracting one or more space regions based on an attribute value of the space region. The matching unit 151 may perform matching by extracting at least one out of one or more augmented reality dioramas and one or more space regions based on fitness between the augmented reality diorama and the space region.

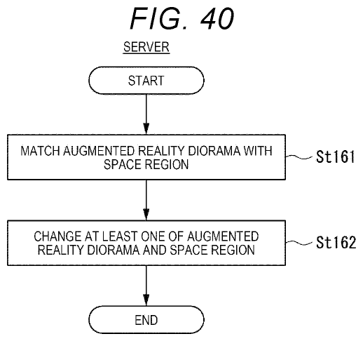

FIG. 40 is a flowchart illustrating an example of a virtual store management process according to at least one embodiment of the present disclosure.

The matching unit 151 matches the augmented reality diorama with the space region (St161). The adjustment unit 152 changes at least one out of at least one augmented reality diorama of the display target and at least one space region in accordance with the other (St162).

Matching the augmented reality diorama with the space region means extracting at least one of the augmented reality diorama and the space region as a linking target. For example, a process of extracting the augmented reality diorama to be linked to the space region from the plurality of augmented reality dioramas when a certain space region is designated corresponds to matching. Conversely, a process of extracting the space region to be linked to the augmented reality diorama from the plurality of space regions when a certain augmented reality diorama is designated corresponds to matching. A process of extracting both of the augmented reality diorama and the space region in accordance with a predetermined standard also corresponds to matching.

Changing of the augmented reality diorama and changing of the space region are the same as described above and thus, will not be described.

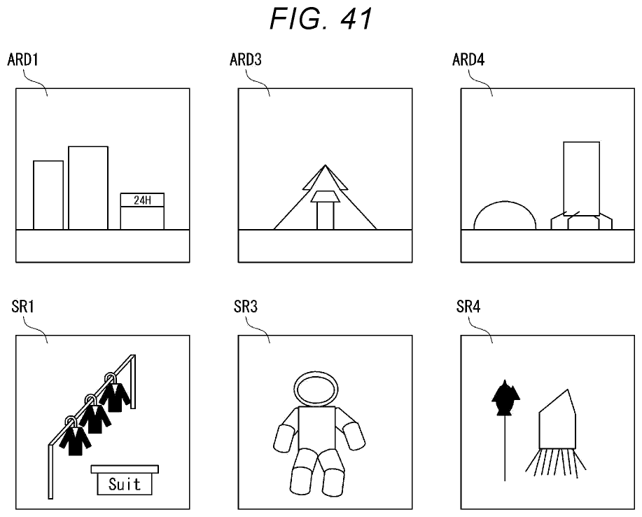

FIG. 41 is a conceptual diagram illustrating an example of a matching process between the augmented reality diorama and the space region according to at least one embodiment of the present disclosure. Here, 3D modeling data related to a plurality of augmented reality dioramas ARD1, ARD3, and ARD4 is stored in the storage device (for example, the storage device 13 illustrated in FIG. 1 or FIG. 14) accessible from the server 10Z. Similarly, 3D modeling data related to a plurality of space regions SR1, SR3, and SR4 is stored in the storage device accessible from the server 10Z.

The augmented reality diorama ARD1 is an augmented reality diorama that reproduces the local area 1 in modern age. Buildings and the like made of reinforced concrete are arranged in the augmented reality diorama ARD1. The augmented reality diorama ARD3 is an augmented reality diorama that reproduces a certain zone in Jomon period. A pit house in Jomon period is arranged in the augmented reality diorama ARD3. The augmented reality diorama ARD4 is an augmented reality diorama that reproduces a lunar city in the year of AD 2100. The augmented reality diorama may reproduce a fictional streetscape based on a city or the like appearing in a comic book as a motif. A base having a dome shape and a residence block separated from a surface of the moon by four arms are arranged in the augmented reality diorama ARD4.

The space region SR1 corresponds to a virtual store selling clothes in modern age. Clothes purchased by the user at the virtual store are delivered to home of the user by mail. The space region SR3 corresponds to a virtual store selling spacesuits in the future. In a case where the user purchases a spacesuit at the virtual store, a sleeping bag having a shape of the spacesuit is delivered to the house of the user by mail. The space region SR4 corresponds to a virtual store selling stone spears in Jomon period and clothes made of animal leather. In a case where the user purchases a stone spear at the virtual store, an item “stone spear” with which a player character can be equipped, and data of “leather clothes” can be obtained in a role-playing game played by the user.

The matching unit 151 may perform matching by extracting one or more augmented reality dioramas based on the attribute value of the augmented reality diorama. For example, the user designates the space region SR1 by operating the user terminal 20 and then, transmits an instruction indicating a desire to search for an augmented reality diorama that fits with the space region SR1 to the server 10Z. The matching unit 151 extracts an augmented reality diorama reproducing any local area of Japan in the year of 2000 to 2020 (modern age) based on the input information. As a result of extraction, a plurality of corresponding augmented reality dioramas may be present. For example, the matching unit 151 extracts one or more augmented reality dioramas based on an attribute value “age reproduced by augmented reality diorama” of the augmented reality diorama. In the present example, the augmented reality diorama ARD1 is extracted. Tag information or the like indicating included attribute values may be added to data of the augmented reality diorama. The attribute value of the augmented reality diorama used for extraction is not limited to the above. For example, various attribute values such as a local area reproduced by the augmented reality diorama, a size of the augmented reality diorama, popularity, the number of times of use, the number of times the augmented reality diorama is used, a genre (near future, modern age, medieval age, ancient age, another world, or the like) to which the augmented reality diorama belongs, a creator of the augmented reality diorama, a created date and time, popularity of the creator of the augmented reality diorama on the SNS service, and the number of times a posted motion picture published by the creator of the augmented reality diorama is played back may be used for extraction.

The matching unit 151 may perform matching by extracting one or more space regions based on the attribute value of the space region. For example, the user designates the augmented reality diorama ARD4 by operating the user terminal 20 and then, transmits an instruction indicating a desire to search for a space region that fits with the augmented reality diorama ARD4 to the server 10Z. The matching unit 151 extracts a space region corresponding to a virtual store selling products that may be related to a space city in the future, based on the input information. As a result of extraction, a plurality of corresponding space regions may be present. For example, the matching unit 151 extracts one or more space regions based on an attribute value “target local area of products dealt at virtual store” of the space region. In the present example, the space region SR3 is extracted. Tag information or the like indicating included attribute values may be added to data of the space region. The attribute value of the space region used for extraction is not limited to the above. For example, various attribute values such as a genre (restaurant, household goods, sports goods, or the like) of the products sold at the virtual store corresponding to the space region (simply referred to as the virtual store), a type of service (teaching vocal techniques, commissioning to create contents, or the like) provided by the virtual store, a local area in which an actual store related to the virtual store is present, target customers of the virtual store, familiarity with the virtual store or the product, evaluation from a consumer of the virtual store or the product, a genre of a product of another brand related to a company providing the virtual store, a creator of the space region, a created date and time, popularity of the creator of the space region on the SNS service, and the number of times a posted motion picture published by the creator of the space region is played back may be used for extraction.

The matching unit 151 may perform matching by extracting at least one out of one or more augmented reality dioramas and one or more space regions based on the fitness between the augmented reality diorama and the space region. For example, the matching unit 151 converts the fitness between both of the augmented reality diorama and the space region into a numerical value based on the tag information (attribute value) added to the data of the augmented reality diorama and the tag information (attribute value) added to the data of the space region. For example, a difference in age between the augmented reality diorama and the space region may be converted into points such that in a case where the difference is within a predetermined number of years, +10 points are provided. The fitness may be converted into a numerical value by adding the points for each attribute value. In addition, the fitness may be converted into a numerical value based on a value (the number of times a Good button is pushed, the number of times of use by the user, or the like) indicating evaluation from the user in a case of linking a certain augmented reality diorama to a certain space region. Besides, a learned model may be created in advance by machine-learning the value indicating the evaluation from the user in a case of linking the augmented reality diorama to the space region. For example, the attribute value of the augmented reality diorama and the attribute value of the space region are input into a neural network, and supervised learning is performed using the value indicating the evaluation from the user as training data. The learned model created in such a manner is stored in the storage device 13 of the server 10Z. Then, an estimated value corresponding to the evaluation from the user is output by causing the matching unit 151 to input the attribute value of the augmented reality diorama and the attribute value of the space region into the learned model. The matching unit 151 may use the estimated value as the fitness between the augmented reality diorama and the space region. The matching unit 151 may calculate the fitness between the augmented reality diorama and the space region using other methods known to those skilled in the art.

The matching unit 151 extracts an augmented reality diorama and/or a space region of which the calculated fitness is higher than a predetermined value. Consequently, for example, a set of the augmented reality diorama ARD1 and the space region SR1, a set of the augmented reality diorama ARD3 and the space region SR4, and a set of the augmented reality diorama ARD4 and the space region SR3 are extracted as a set having high fitness.

Here, the adjustment unit 152 has a function of changing at least one out of at least one augmented reality diorama of the display target and at least one space region in accordance with the other. The adjustment unit 152 may change at least one of the augmented reality diorama and the space region such that the value of the fitness is increased. For example, the adjustment unit 152 changes a streetscape of the augmented reality diorama to a streetscape of an age that fits with the space region. In addition, for example, the adjustment unit 152 changes the interior of the virtual store, which is the space region, to have an appearance that fits with the augmented reality diorama.

As described above, by causing the matching unit 151 to match the augmented reality diorama with the space region, the space region fitting with the augmented reality diorama and the augmented reality diorama fitting with the space region can be easily found and provided to the user of the virtual store management system 100. The user of the virtual store management system 100 includes the creator of the augmented reality diorama, the creator of the space region corresponding to the virtual store, the user having the user terminal 20, and the like.

In addition, by causing the adjustment unit 152 to change at least one out of at least one augmented reality diorama of the display target and at least one space region in accordance with the other, the fitness between the augmented reality diorama and the space region linked to each other can be increased.

Arrangement of Virtual Object

Next, a function of arranging the virtual object will be described with reference to FIG. 19 again. The first arrangement unit 161 has a function of arranging the virtual object in the space region. The second arrangement unit 162 has a function of arranging the virtual object in the augmented reality diorama.

As described above, the virtual object means an object that can be output in the virtual space. The augmented reality diorama means a virtual diorama displayed in a superimposed manner on the real space. The virtual space region is a region corresponding to the virtual store managed by the virtual store management program in a virtual space. That is, since both of the augmented reality diorama and the space region are virtual spaces, the virtual object can be arranged.

For example, the operator of the virtual store can arrange the article or the product related to provision of the service in the virtual store of the operator as the virtual object by the first arrangement unit 161. That is, the operator of the virtual store can customize the virtual store.

The creator of the augmented reality diorama, the operator of the virtual store, the user, and the like can arrange a building, the article and the product related to provision of the service, the avatar of the user, and the like in the augmented reality diorama as the virtual object by the second arrangement unit 162. That is, a landscape of the augmented reality diorama can be customized, and the article or the product related to provision of the service can be tried or be caused to be tried by another person.

As an aspect of the ninth embodiment, the user can perform various transaction actions in a preferred virtual space. In addition, since the virtual store can be dynamically constructed in an associated state with the augmented reality diorama, the virtual space can be flexibly utilized in transaction.

As an aspect of the ninth embodiment, the user visiting the virtual store can try the product or the service in the virtual space before purchase using the avatar showing the alter ego or the like.

As an aspect of the ninth embodiment, the product or the service can be tried in a state like the avatar is present in the real space.

As an aspect of the ninth embodiment, an avatar does not need to be newly created by, for example, scanning a body of the user, and the avatar stored as a template can be used.

As an aspect of the ninth embodiment, an avatar having a parameter or a form appropriate for trying the product or the service can be obtained by customizing the avatar.

As an aspect of the ninth embodiment, another person can be prevented from knowing information corresponding to personal information of the user among parameters of the avatar.

As an aspect of the ninth embodiment, for example, the user visiting the virtual store can receive various types of convenience such as purchasing the product and obtaining the permission for use in the virtual space. In a case where the user pays the price for acquiring the permission, the user can perform commercial transaction or settlement in the cashier region.

As an aspect of the ninth embodiment, the user can perform transaction for the product or the service of the virtual store through the transaction screen.

As an aspect of the ninth embodiment, the user can be served through the reception character.

As an aspect of the ninth embodiment, the user can be served by a desired reception character in accordance with the actual article such as the figure of the user.

As an aspect of the ninth embodiment, the number of persons for serving at the virtual store can be reduced.

As an aspect of the ninth embodiment, various persons such as the store clerk of the virtual store can serve the user through the virtual store.

As an aspect of the ninth embodiment, the space region can be removed from the augmented reality diorama.

As an aspect of the ninth embodiment, the space region corresponding to the store can be dynamically merged. Thus, a virtual complex store or a virtual shopping mall can be flexibly constructed in accordance with the needs of the user. The user can perform transaction at the virtual complex store or the virtual shopping mall that matches the preference of the user.

As an aspect of the ninth embodiment, a plurality of space regions in a state of being changed for fitting with each other can be merged.

As an aspect of the ninth embodiment, the space regions can be smoothly merged.

As an aspect of the ninth embodiment, the space region of the merging target can be presented on the system side.

As an aspect of the ninth embodiment, by merging a plurality of augmented reality dioramas resembling different places into one augmented reality diorama, a free streetscape that overcomes geographical restrictions in the real world can be reproduced in the AR space. Furthermore, the user can perform more flexible and free transaction by using the virtual store (space region) arranged in the streetscape overcoming the geographical restrictions in the real world.

As an aspect of the ninth embodiment, a plurality of augmented reality dioramas in a state of being changed for fitting with each other can be merged.

As an aspect of the ninth embodiment, the augmented reality dioramas can be smoothly merged.

As an aspect of the ninth embodiment, the augmented reality diorama of the merging target can be presented on the system side.

As an aspect of the ninth embodiment, for example, the space region and/or the augmented reality diorama of the target of linking can be found from multiple space regions and/or augmented reality dioramas registered in the storage device in accordance with the predetermined standard.

As an aspect of the ninth embodiment, for example, an augmented reality diorama preferred by the operator of the virtual store can be extracted based on the attribute value.

As an aspect of the ninth embodiment, for example, a space region preferred by the creator of the augmented reality diorama can be extracted based on the attribute value.

As an aspect of the ninth embodiment, a set of an augmented reality diorama and a space region having high fitness for each other can be presented on the system side.

As an aspect of the ninth embodiment, the fitness between the augmented reality diorama and the space region to be linked to each other can be increased.

As an aspect of the ninth embodiment, for example, the operator of the virtual store can arrange the article or the product related to provision of the service in the virtual store of the operator as the virtual object. Accordingly, the virtual store can be customized.

As an aspect of the ninth embodiment, the creator of the augmented reality diorama, the operator of the virtual store, the user, and the like can arrange a building, the article and the product related to provision of the service, the avatar of the user, and the like in the augmented reality diorama as the virtual object. Accordingly, the landscape of the augmented reality diorama can be customized, and the article or the product related to provision of the service can be tried or be caused to be tried by another person.

As described above, each embodiment of the present application solves one or two or more deficiencies. Effects of each embodiment are non-limiting effects or an example of effects.

In each embodiment, the plurality of user terminals 20 and 20A to 20C and the server 10 execute the above various processes in accordance with various control programs (for example, the virtual store management program) stored in the respective storage devices thereof.

In addition, the configurations of the virtual store management system 100 and the virtual store management system 100A are not limited to the configurations described as an example of each embodiment. For example, a part or all of the processes described as a process executed by the user terminal may be configured to be executed by the server 10. A part or all of the processes described as a process executed by the server 10 may be configured to be executed by any of the plurality of user terminals 20 and 20A to 20C. In addition, a part or the entire storage unit (storage device) included in the server 10 may be configured to be included in any of the plurality of user terminals 20 and 20A to 20C. That is, a part or all of the functions included in any one of the user terminal and the server in the virtual store management system 100 or the virtual store management system 100A may be configured to be included in the other.

In addition, the program may be caused to implement a part or all of the functions described as an example of each embodiment in a single apparatus not including the communication network.

### APPENDIX

The above description of the embodiments is disclosed in order for those of ordinary knowledge in the field of the disclosure to embody at least the following disclosure.

[1]

A virtual store management program causing a server to implement an augmented reality diorama display function of displaying an augmented reality diorama superimposed on a real space on a display device, a space region link function of linking one or more virtual space regions to the augmented reality diorama, and a space region display function of displaying the space region linked to the augmented reality diorama on the display device.

[2-1]

The virtual store management program according to [1], further causing the server to implement an avatar display function of displaying a virtual avatar associated with a user on the display device together with the augmented reality diorama or the space region, and a combining function of combining the avatar with a virtual object having a predetermined correspondence relationship with the space region.

[2-2]

The virtual store management program according to [2-1], in which in the avatar display function, a function of displaying the avatar in AR on the display device is implemented.

[2-3]

The virtual store management program according to [2-1] or [2-2], further causing the server to implement an avatar link function of associating any one or more of a plurality of virtual avatars with the user in accordance with input information.

[2-4]

The virtual store management program according to any one of [2-1] to [2-3], further causing the server to implement an avatar editing function of changing a parameter or a form of the avatar in accordance with input information.

[2-5]

The virtual store management program according to any one of [2-1] to [2-4], further causing the server to implement a privacy protection function of restricting disclosure of one or more parameters of the avatar associated with the user to another user different from the user.

[3-1]

The virtual store management program according to any one of [1] to [2-5], further causing the server to implement a cashier region display function of displaying a virtual cashier region for causing a user to acquire a predetermined permission for a virtual object having a predetermined correspondence relationship with the space region or an object in the real space corresponding to the object, on the display device in association with the space region.

[3-2]

The virtual store management program according to [3-1], in which in the cashier region display function, a function of displaying a transaction screen for transaction on the display device is implemented.

[3-3]

The virtual store management program according to [3-1] or [3-2], further causing the server to implement a reception character display function of displaying one or more reception characters that serve the user on the display device together with the cashier region.

[3-4]

The virtual store management program according to [3-3], in which in the reception character display function, a function of displaying the reception character having a parameter or a form corresponding to an actual article usable in the real space by the user on the display device together with the cashier region is implemented.

[3-5]

The virtual store management program according to [3-3] or [3-4], in which the reception character is automatically controlled.

[3-6]

The virtual store management program according to [3-3] or [3-4], in which the reception character is controllable by a person other than the user.

[4]

The virtual store management program according to any one of [1] to [3-6], further causing the server to implement a space region link canceling function of canceling a link between the augmented reality diorama and one or more space regions.

[5-1]

The virtual store management program according to any one of [1] to [4], further causing the server to implement a space region merging function of merging two or more of the space regions.

[5-2]

The virtual store management program according to [5-1], in which in the space region merging function, a function of changing at least one space region of a merging target in accordance with at least the other space region of the merging target and then, merging both space regions is implemented.

[5-3]

The virtual store management program according to [5-1] or [5-2], in which in the space region merging function, a function of providing a connection region between at least one space region of a merging target and at least the other space region of the merging target and then, merging both space regions is implemented.

[5-4]

The virtual store management program according to any one of [5-1] to [5-3], further causing the server to implement a space region selection function of selecting two or more space regions of merging targets by the space region merging function based on at least one of input information provided by a user and predetermined accumulated information.

[6-1]

The virtual store management program according to any one of [1] to [5-4], further causing the server to implement an augmented reality diorama merging function of merging two or more augmented reality dioramas.

[6-2]

The virtual store management program according to [6-1], in which in the augmented reality diorama merging function, a function of changing at least one augmented reality diorama of a merging target in accordance with at least the other augmented reality diorama of the merging target and then, merging both augmented reality dioramas is implemented.

[6-3]

The virtual store management program according to [6-1] or [6-2], in which in the augmented reality diorama merging function, a function of providing a connection region between at least one augmented reality diorama of a merging target and at least the other augmented reality diorama of the merging target and then, merging both augmented reality dioramas is implemented.

[6-4]

The virtual store management program according to any one of [6-1] to [6-3], further causing the server to implement an augmented reality diorama selection function of selecting two or more augmented reality dioramas of merging targets by the augmented reality diorama merging function based on at least one of input information provided by a user and predetermined accumulated information.

[7-1]

The virtual store management program according to any one of [1] to [6-4], further causing the server to implement a matching function of matching the augmented reality diorama with the space region.

[7-2]

The virtual store management program according to [7-1], in which in the matching function, the matching is performed by extracting one or more augmented reality dioramas based on an attribute value of the augmented reality diorama.

[7-3]

The virtual store management program according to [7-1], in which in the matching function, the matching is performed by extracting one or more space regions based on an attribute value of the space region.

[7-4]

The virtual store management program according to [7-1], in which in the matching function, the matching is performed by extracting at least one out of one or more augmented reality dioramas and one or more space regions based on fitness between the augmented reality diorama and the space region.

[7-5]

The virtual store management program according to any one of [1] to [7-4], further causing the server to implement an adjustment function of changing at least one out of at least one augmented reality diorama of a display target and at least one space region in accordance with the other.

[8]

The virtual store management program according to any one of [1] to [7-5], further causing the server to implement a first arrangement function of arranging a virtual object in the space region.

[9]

The virtual store management program according to any one of [1] to [8], further causing the server to implement a second arrangement function of arranging a virtual object in the augmented reality diorama.

[10]

A program causing a user terminal capable of communicating with the server to implement at least one function of the functions that the server is caused to implement by the virtual store management program according to any one of [1] to [9].

[11]

A server on which the virtual store management program according to any one of [1] to [9] is installed.

[12]

A virtual store management system including a communication network, a server, and a user terminal, the virtual store management system including augmented reality diorama display means for displaying an augmented reality diorama superimposed on a real space on a display device, space region link means for linking one or more virtual space regions to the augmented reality diorama, and space region display means for displaying the space region linked to the augmented reality diorama on the display device.

[13]

A virtual store management program causing a user terminal to implement an augmented reality diorama display function of displaying an augmented reality diorama superimposed on a real space on a display device, a space region link function of linking one or more virtual space regions to the augmented reality diorama, and a space region display function of displaying the space region linked to the augmented reality diorama on the display device.

[14]

A user terminal on which the virtual store management program according to [13] is installed.

[15]

A virtual store management program causing a computer apparatus to implement an augmented reality diorama display function of displaying an augmented reality diorama superimposed on a real space on a display device, a space region link function of linking one or more virtual space regions to the augmented reality diorama, and a space region display function of displaying the space region linked to the augmented reality diorama on the display device.

[16]

A virtual store management method by a computer apparatus, the virtual store management method including an augmented reality diorama display process of displaying an augmented reality diorama superimposed on a real space on a display device, a space region link process of linking one or more virtual space regions to the augmented reality diorama, and a space region display process of displaying the space region linked to the augmented reality diorama on the display device.

[17]

A virtual store management method by a virtual store management system including a communication network, a server, and a user terminal, the virtual store management method including an augmented reality diorama display process of displaying an augmented reality diorama superimposed on a real space on a display device, a space region link process of linking one or more virtual space regions to the augmented reality diorama, and a space region display process of displaying the space region linked to the augmented reality diorama on the display device.

### INDUSTRIAL APPLICABILITY

One embodiment of the present disclosure is useful as a non-transitory computer readable medium storing a virtual store management program enabling a user to perform various transaction actions in a preferred virtual space, and a virtual store management system.

What is claimed is:

1. A non-transitory computer readable medium storing a virtual store management program causing a server to perform:
displaying an augmented reality diorama superimposed on a view of a real space on a display device;
linking one or more virtual space regions to the augmented reality diorama; and
displaying the space region linked to the augmented reality diorama on the display device.

2. The non-transitory computer readable medium according to claim 1,
wherein the virtual store management program further causes the server to perform:
displaying an avatar associated with a user on the display device together with the augmented reality diorama or the space region; and
combining the avatar with a virtual object having a predetermined correspondence relationship with the space region.

3. The non-transitory computer readable medium according to claim 2, wherein displaying the avatar comprises displaying the avatar in an augmented reality (AR) space on the display device.

4. The non-transitory computer readable medium according to claim 2,
wherein the virtual store management program further causes the server to perform associating one or more avatars of a plurality of avatars with the user in accordance with input information.

5. The non-transitory computer readable medium according to claim 2,
wherein the virtual store management program further causes the server to perform changing at least one of a parameter or a form of the avatar in accordance with input information.

6. The non-transitory computer readable medium according to claim 2,
wherein the virtual store management program further causes the server to perform restricting disclosure of one or more parameters of the avatar associated with the user to another user different from the user.

7. The non-transitory computer readable medium according to claim 1,
wherein the virtual store management program further causes the server to perform displaying a virtual cashier region for causing a user to obtain a predetermined permission for either a virtual object having a predetermined correspondence relationship with the space region or another object in the real space corresponding to the object, on the display device in association with the space region.

8. The non-transitory computer readable medium according to claim 7, wherein displaying the virtual cashier region comprises displaying a transaction screen for transaction on the display device.

9. The non-transitory computer readable medium according to claim 7, wherein the virtual store management program further causes the server to perform displaying one or more reception characters configured to serve the user on the display device together with the cashier region.

10. The non-transitory computer readable medium according to claim 9, wherein displaying the one or more reception characters comprises displaying the reception character having at least one of a parameter or a form corresponding to an article configured to be used in the real space by the user on the display device together with the cashier region.

11. The non-transitory computer readable medium according to claim 9, wherein the virtual store management program further causes the server to control the reception character automatically.

12. The non-transitory computer readable medium according to claim 9, wherein the virtual store management program further causes the server to control the reception character responsive to a person other than the user.

13. The non-transitory computer readable medium according to claim 1,
wherein the virtual store management program further causes the server to perform canceling a link between the augmented reality diorama and one or more space regions.

14. The non-transitory computer readable medium according to claim 1,
wherein the virtual store management program further causes the server to perform merging two or more space regions.

15. The non-transitory computer readable medium according to claim 14, wherein merging the two or more space regions comprises:
changing at least one space region of a merging target in accordance with at least the other space region of the merging target; and
merging the at least one space region and the at least the other space region.

16. The non-transitory computer readable medium according to claim 14, wherein merging the two or more space regions comprises:
providing a connection region between at least one space region of a merging target and at least the other space region of the merging target; and
merging the at least one space region and the at least the other space region.

17. The non-transitory computer readable medium according to claim 1,
wherein the virtual store management program further causes the server to perform merging two or more augmented reality dioramas.

18. The non-transitory computer readable medium according to claim 1,
wherein the virtual store management program further causes the server to perform matching the augmented reality diorama with the space region.

19. A virtual store management system comprising:
a communication network;
a server;
a user terminal; and
a computer in at least one of the server or the user terminal, the computer being configured to:
display an augmented reality diorama superimposed on a real space on a display device;
link one or more virtual space regions to the augmented reality diorama; and
display the space region linked to the augmented reality diorama on the display device.

20. A non-transitory computer readable medium storing a virtual store management program causing a user terminal to perform:
displaying an augmented reality diorama superimposed on a view of a real space on a display device;
linking one or more virtual space regions to the augmented reality diorama; and
displaying the space region linked to the augmented reality diorama on the display device.
